(19) United States
(12) Patent Application Publication
(10) Pub. No.: US 2014/0085674 A1
(43) Pub. Date: Mar. 27, 2014

(54) INFORMATION PROCESSING APPARATUS, CONTROL METHOD, AND PROGRAM

(71) Applicant: CANON KABUSHIKI KAISHA, Tokyo (JP)

(72) Inventor: Yuichi Hasama, Kawasaki-shi (JP)

(73) Assignee: CANON KABUSHIKI KAISHA, Tokyo (JP)

(21) Appl. No.: 14/037,952

(22) Filed: Sep. 26, 2013

(30) Foreign Application Priority Data
Sep. 27, 2012 (JP) 2012-214269

(51) Int. Cl. G06F 3/12

(52) U.S. Cl. CPC G06F 3/126
USPC 358/1.15

(57) ABSTRACT

An information processing apparatus includes a determination unit configured to determine whether there exists a printer queue which is to be managed by a device management application which is installed together with a device driver, and a display control unit configured to, when the printer queue is determined to exist and a peripheral apparatus is selected, display a first screen for displaying information about the selected peripheral apparatus, and to, when the printer queue is determined not to exist, display a second screen different from the first screen.

### BACKGROUND OF THE INVENTION

1. Field of the Invention

The present invention relates to an information processing apparatus capable of managing a plurality of peripheral apparatuses, an information processing method, and a program.

2. Description of the Related Art

Japanese Patent Application Laid-Open No. 2010-123103 discusses a technique for associating a device management system with device drivers by describing a plurality of driver names in an extended markup language (XML).

### SUMMARY OF THE INVENTION

According to an aspect of the present invention, an information processing apparatus includes a determination unit configured to determine whether there exists a printer queue which is to be managed by a device management application which is installed together with a device driver, and a display control unit configured to, when the printer queue is determined to exist and a peripheral apparatus is selected, display a first screen for displaying information about the selected peripheral apparatus, and to, when the printer queue is determined not to exist, display a second screen different from the first screen.

Further features of the present invention will become apparent from the following description of exemplary embodiments with reference to the attached drawings.

### BRIEF DESCRIPTION OF THE DRAWINGS

FIG. 1A is block diagram illustrating a hardware configuration of a computer system, and FIG. 1B is block diagram illustrating a software configuration of the computer system.

FIG. 2 illustrates a configuration of a network to which clients, a server, and peripheral apparatuses are connected.

FIGS. 3A and 3B illustrate examples of tile screens of a device management application.

FIG. 4 is a flowchart illustrating procedures for installing the device management application.

FIG. 5 is a Unified Modeling Language (UML) diagram illustrating relations among a device ID of a peripheral apparatus, the device management application, a device management system, a device driver, and a printer queue.

FIG. 6 is a flowchart illustrating processing for activating the device management application.

FIGS. 7A and 7B illustrate examples of preparation screens of the device management application.

FIG. 8 illustrates an example of an end user license agreement (EULA) screen of the device management application.

FIG. 9 is a flowchart illustrating processing for displaying a selection screen of the device management application.

FIG. 10A is a flowchart illustrating processing for displaying a device selection screen of the device management application, and FIG. 10B is a flowchart illustrating processing performed when a printer device button is pressed.

FIGS. 11A, 11B, and 11C illustrate examples of device selection screens of the device management application.

FIG. 12A is a flowchart illustrating processing for displaying a function selection screen of the device management application, and FIG. 12B is a flowchart illustrating processing performed when a function selection button is pressed.

FIGS. 13A, 13B, 13C, and 13D illustrate examples of function selection screens of the device management application.

FIG. 14A is a flowchart illustrating processing for generating a tile of the device management application, and FIG. 14B is a flowchart illustrating processing for deleting a tile of the device management application.

FIG. 15A is a flowchart illustrating processing for displaying a support selection screen of the device management application, and FIGS. 15B and 15C illustrate examples of support selection screens of the device management application.

FIG. 16 is a flowchart illustrating processing for activating a tile of the device management application.

FIG. 17 is a flowchart illustrating processing for displaying a website with the device management application.

FIGS. 18A and 18B illustrate examples of website display.

FIG. 19 illustrates an example of a setting screen of the device management application.

FIGS. 20A, 20B, 20C, 20D, and 20E illustrate examples of messages of the device management application.

### DESCRIPTION OF THE EMBODIMENTS

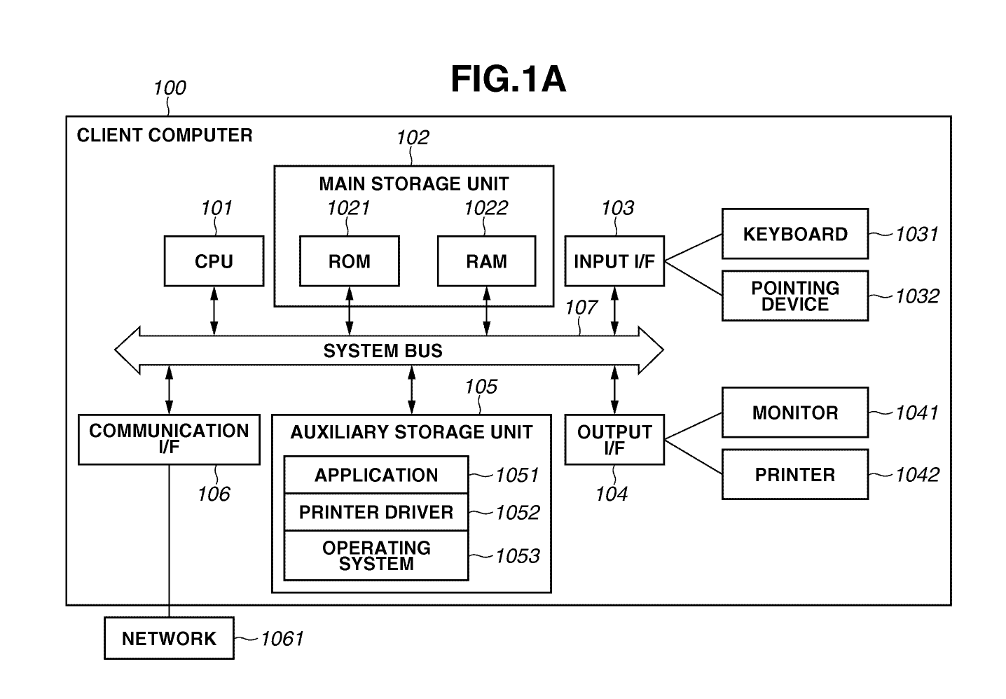

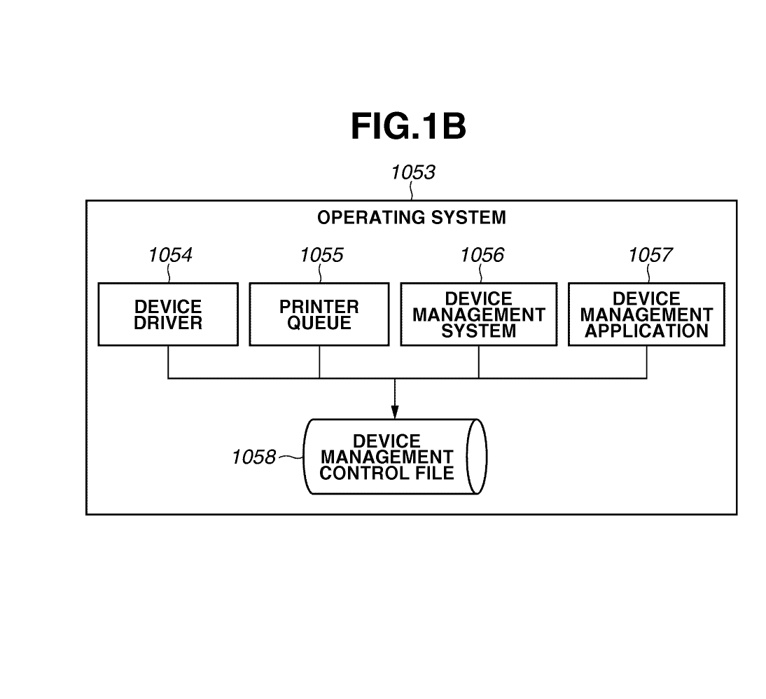

FIGS. 1A and 1B are block diagrams of an ordinary computer system according to an exemplary embodiment of the present invention. Unless otherwise specified, the present invention is of course applicable to a single function, a system including a plurality of devices, and a system connected via a network to perform processing, as long as functions of the present invention are performed.

A client computer (information processing apparatus) 100 has a hardware configuration illustrated in FIG. 1A. The hardware configuration will be described in detail below.

A central processing unit (CPU) 101 controls the entire apparatus according to a program stored in a main storage unit 102 including a read-only memory (ROM) 1021 or a random access memory (RAM) 1022, or in an auxiliary storage unit 105. Although, in the present exemplary embodiment, the client computer 100 includes one CPU 101, the client computer 100 may include a plurality of CPUs. In other words, the client computer 100 desirably includes at least one CPU. The RAM 1022 is used also as a work area by the CPU 101 to perform various processing. The auxiliary storage unit 105 stores an operating system (OS) 1053 and application software 1051. In the following descriptions, the main storage unit 102 and the auxiliary storage unit 105 are collectively referred to as a storage unit.

Input devices, such as a pointing device 1032 and a keyboard 1031, represented by a mouse and a touch panel, are connected via an input interface (I/F) 103. Input devices are used to give various instructions to the client computer 100.

An output I/F 104 serves as an interface for outputting data to outside devices, such as a monitor 1041 and a multifunction peripheral (MFP) 1042. The peripheral apparatus 1042 may not be directly connected via a local input/output (I/O). Specifically, the peripheral apparatus 1042 may be connected via a network 1061 connected via a communication I/F 106.

A common data system bus 107 allows data exchange between the above-described interfaces and modules. The peripheral apparatus 1042 may be a printer and a multifunction peripheral (MFP). Hereinafter, the peripheral apparatus 1042 is simply referred to as a printer 1042.

In addition, the software configuration of the client computer 100, as illustrated in FIG. 1B, and processing of each step of flowcharts (described below) are implemented when the CPU 101 executes processing according to a program stored in the storage unit.

A device driver 1054 and a printer queue 1055 store a device identifier (ID) corresponding to a connected printer 1042.

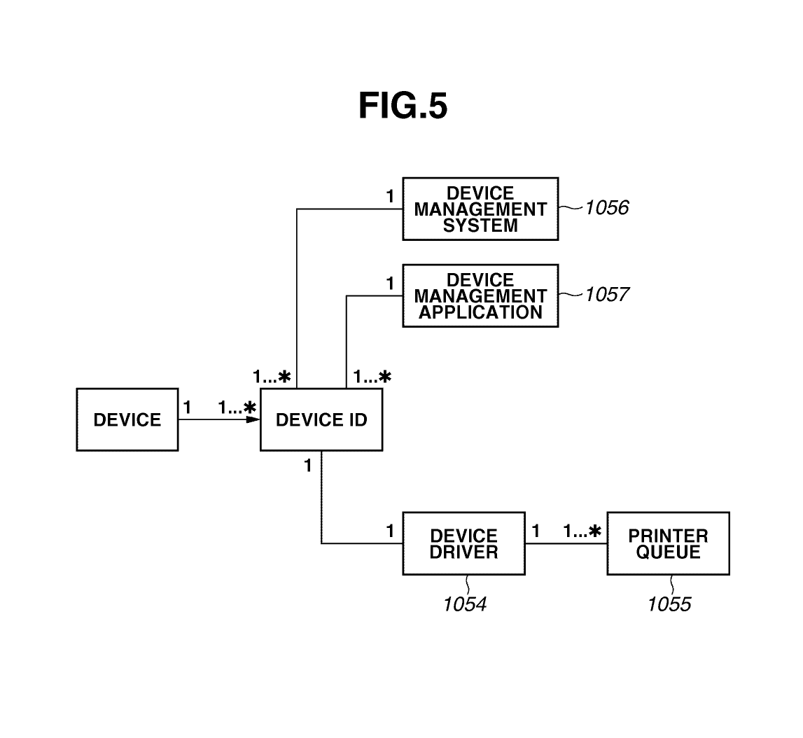

A device management control file 1058 describes an association among the device identifier (ID), a device management system 1056, and a device management application 1057 (see Table A below and FIG. 5 for details). Referring to the device management control file 1058, the OS 1053 can determine how the device driver 1054, the printer queue 1055, the device management system 1056, and the device management application 1057 are associated with each other.

The device management control file 1058 may be generated for each model or for all models.

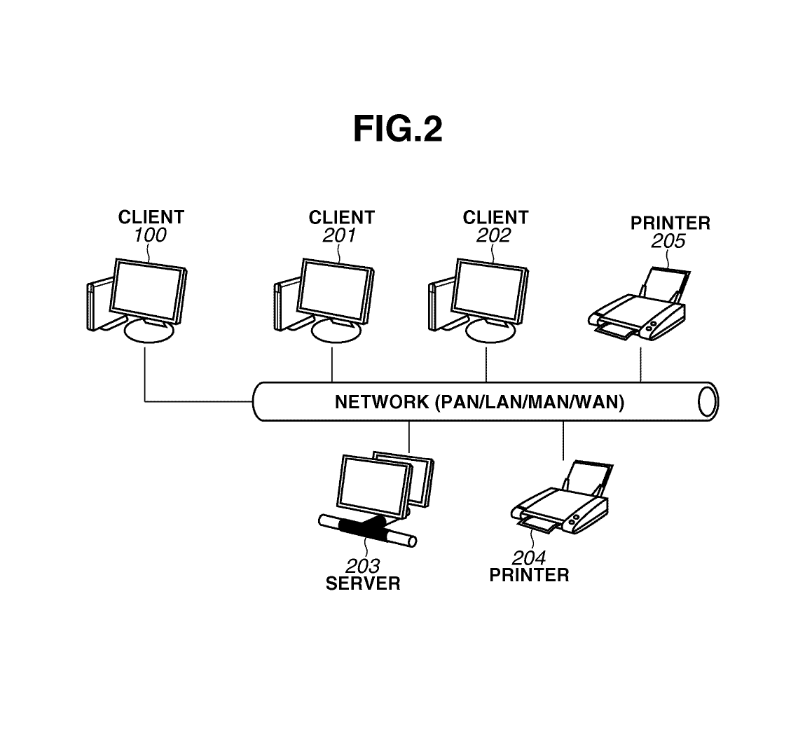

FIG. 2 schematically illustrates an environment of the network 1061 according an exemplary embodiment of the present invention. At least one of client computers 100, 201, and 202 for generating documents and images to be printed is connected to a network 1061. In some cases, a server computer 203 for managing users of the client computers 100, 201, and 202, and the printer 1042 is connected to the network 1061. At least one of printers 204 and 205 is connected to the network 1061. In some cases, similar to the printer 205, the printers 204 and 205 are in the offline state where they are not actually usable even if they are physically connected. The network 1061 includes small- to large-scale networks, such as a personal area network (PAN), a local area network (LAN), a metropolitan area network (MAN), and a wide area network (WAN). The above-described devices are connected to all of the networks. Servers and printers may be connected beyond the Internet, such as a cloud.

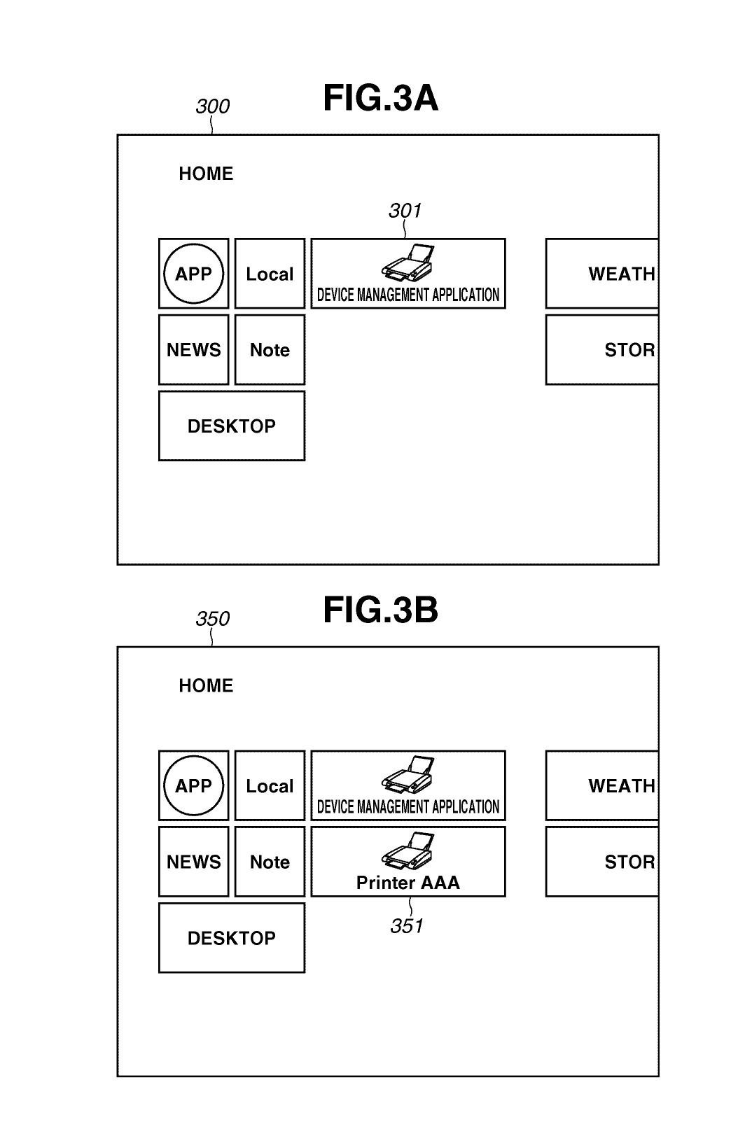

FIGS. 3A and 3B illustrate example of a tile screen of the device management application 1057.

As illustrated in FIG. 3A, the OS 1053 displays each function in tile form. The OS 1053 displays a tile 301 of the device management application 1057 as one tile. In the present specifications, for convenience, a screen 300 illustrated in FIG. 3A is referred to as a home screen. The home screen 300 is offered by the OS 1053 to display information offered by various applications installed in the OS 1053, and to activate an application when a click or touch operation is received from a user.

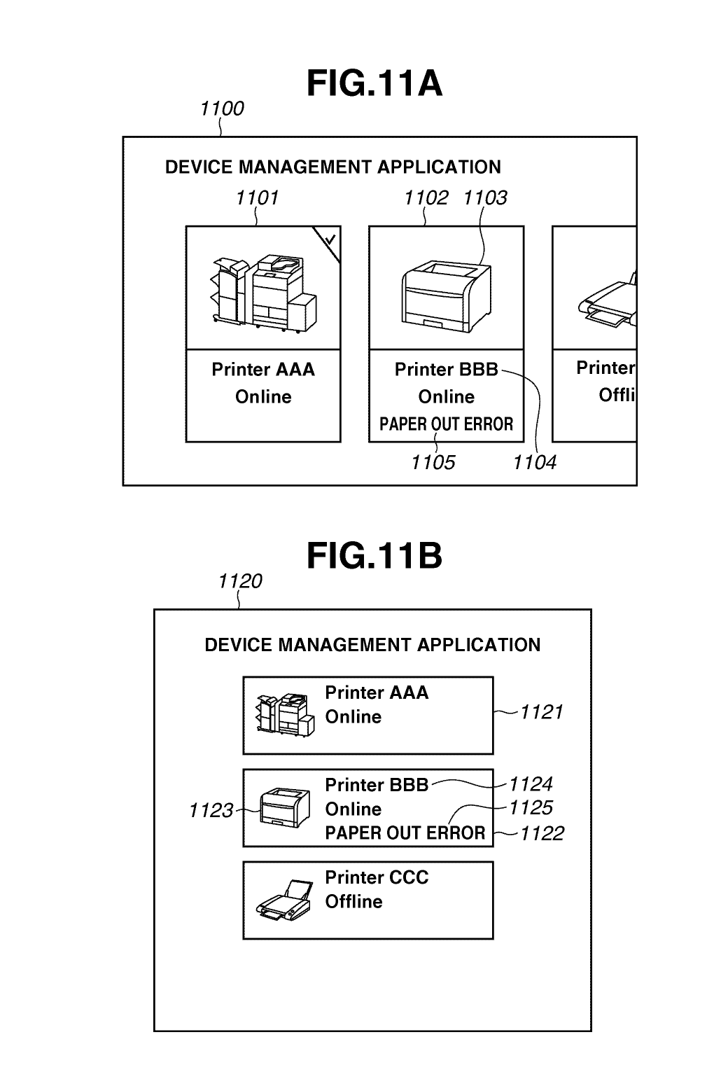

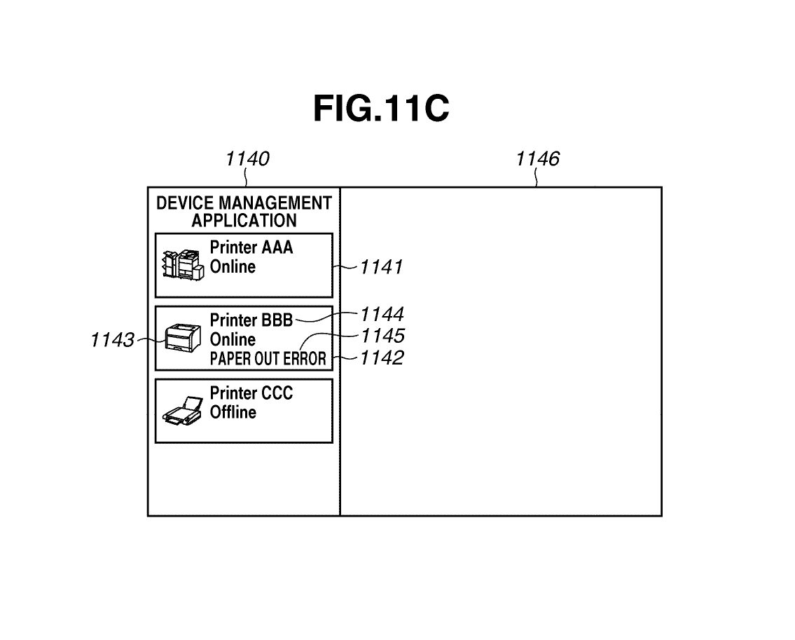

When the user clicks the tile 301, a printer status screen 1100 (FIG. 11A) is displayed. The printer status screen 1100 displays statuses of printers managed by (or associated with) the device management application 1057 corresponding to the tile 301. The device management application 1057 offers the screen 1100, which enables the user to check information (such as the printer name and printer external view) about printers associated with the device management application 1057, and present status information 1105 and consumable goods of each printer.

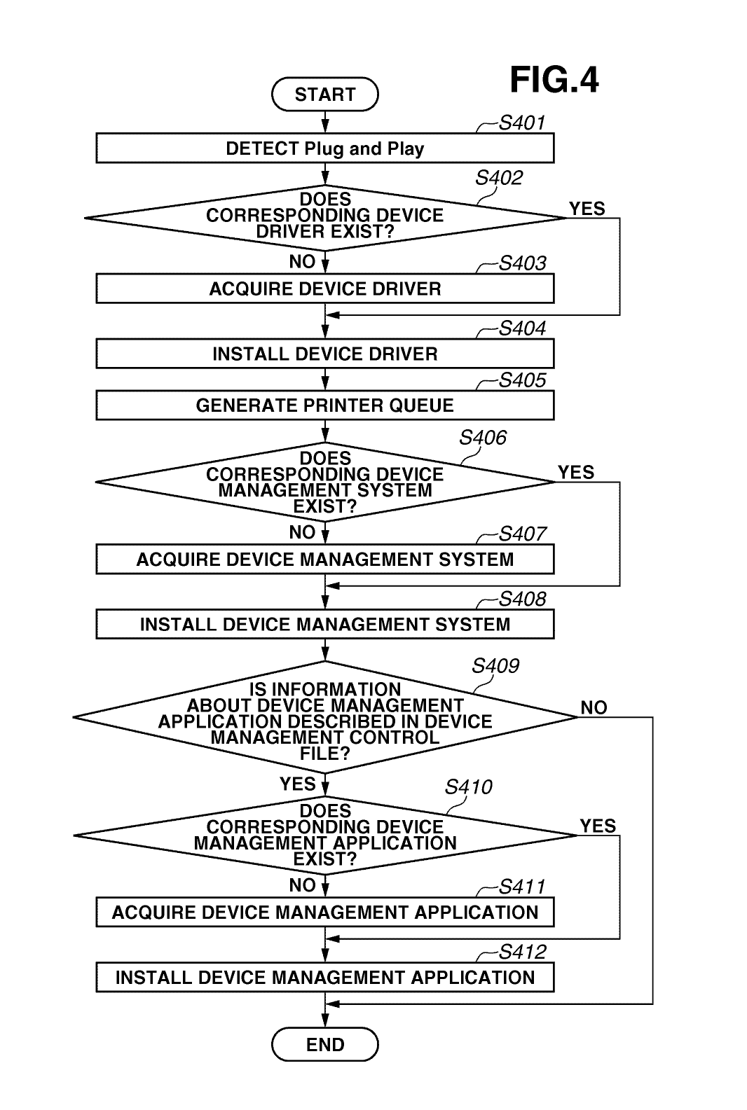

FIG. 4 is a flowchart illustrating procedures for installing the device management application 1057 when the printer queue 1055 is generated.

In step S401, the OS 1053 detects that a printer has been connected to the output I/F 104. This step is achieved by the Plug and Play (PnP) function pre-installed as standard in the OS 1053. This also applies to a case where the OS 1053 detects that a printer has been connected via the network 1061 connected via the communication I/F 106. The PnP function in network connection in this case is achieved by the Network Plug and Play (N-PnP) function.

In step S402, the OS 1053 determines, through a search, whether the device driver 1054 corresponding to the connected printer exists in the storage unit of the client computer 100. When the corresponding device driver 1054 is determined not to exist as a result of the search (NO in step S402), then in step S403, the OS 1053 acquires the device driver 1054. The OS 1053 acquires the device driver 1054 from a storage medium, such as a compact disc read only memory (CD-ROM), inserted in the client computer 100, a storage unit of the server computer 203 connected via the LAN, or a cloud server via the Internet. When the corresponding device driver 1054 is determined to exist as a result of the search (YES in step S402), the processing proceeds to step S404.

In step S404, the OS 1053 installs in the client computer 100 the device driver 1054 acquired in step S403.

In step S405, the OS 1053 generates the printer queue 1055 corresponding to the connected printer.

In step S406, the OS 1053 determines, through a search, whether the device management system 1056 corresponding to the printer connected to the client computer 100 exists in the storage unit of the client printer 100. When the corresponding device management system 1056 is determined to exist as a result of the search (YES in step S406), the processing proceeds to step S408. Otherwise, when the corresponding device management system 1056 is determined not to exist as a result of the search (NO in step S406), then in step S407, the OS 1053 acquires the corresponding device management system 1056.

Similar to the device driver 1054, the OS 1053 acquires the device management system 1056 from a storage medium, such as a CD-ROM, inserted in the client computer 100, a storage unit of the server computer 203 connected via the LAN, or a cloud server via the Internet.

When acquiring the device management system 1056, the OS 1053 also acquires the device management control file 1058 at the same time. The device management control file 1058 describes related information for associating the connected printer, the device management system 1056, and the device management application 1057 with each other, and stores the information described in Table A (described below).

In step S408, the OS 1053 installs the device management system 1056. In step S409, the OS 1053 determines, through a search, whether information about the device management application 1057 is described in the device management control file 1058. When the information about the device management application 1057 is determined not to be described in the device management control file 1058 as a result of the search (NO in step S409), the processing exits this flowchart.

Otherwise, when the information about the device management application 1057 is determined to be described in the device management control file 1058 (YES in step S409), then in step S410, the OS 1053 determines, through a search, whether the device management application 1057 corresponding to the printer connected to the client computer 100 exists in the storage unit of the client computer 100.

When the corresponding device management application 1057 is determined not to exist as a result of the search (NO in step S410), then in step S411, the OS 1053 acquires the corresponding device management application 1057. The OS 1053 acquires the device management application 1057 from a storage medium, such as a CD-ROM, inserted in the client computer 100, a storage unit of the server computer 203 connected via the LAN, or a cloud server via the Internet.

In step S412, the OS 1053 installs the device management application 1057. The installed device management application 1057 is displayed as a tile, as illustrated by the tile 301 in FIG. 3A.

FIG. 5 illustrates the Unified Modeling Language (UML) diagram illustrating relations among the device ID of a printer device, the device management application 1057, the device management system 1056, the device driver 1054, and the printer queue 1055.

Each printer has the device ID. A printer may have a plurality of device IDs. For example, when the peripheral apparatus 1042 is an MFP, the peripheral apparatus 1042 may have a different device ID for each function, such as a scanner and a printer.

The device ID and the device driver 1054 are uniquely associated with each other.

The relation between the device driver 1054 and the printer queue 1055 is such that a device driver can be associated with a plurality of printer queues.

Further, the device management system 1056 and the device management application 1057 are associated with the device ID. One device management system 1056 can be associated with a plurality of device IDs. Likewise, one device management application 1057 can be associated with a plurality of device IDs.

Thus, the device management application 1057 and the device management system 1056 are associated with the device driver 1054 and the printer queue 1055 via the device ID.

The following describes how the device ID, the device management application 1057, and device management system 1056 are specifically associated with each other, with reference to Table A.

Table A indicates the relation between the device ID, the device management system 1056, and the device management application 1057 for each printer described in the device management control file 1058.

TABLE A

| | | Device | Device |
|---|---|---|---|
| Device | | management | management |
| name | Device ID | system | application |
| Printer 1 | MFG:ABC;MDL:PRINTER1;CLS:PRINTER; | DevMg1 | App1 |
| | CMD:PDL1;DES:ABC PRINTER1 | | |
| Printer 2 | MFG:ABC;MDL:PRINTER2;CLS:PRINTER; | DevMg2 | App1 |
| | CMD:PDL1;DES:ABC PRINTER2 | | |
| Printer 3 | MFG:ABC;MDL:PRINTER3;CLS:PRINTER; | DevMg3 | App2 |
| | CMD:PDL2;DES:ABC PRINTER3 | | |

The device ID is information including a manufacturer (MFG), a model (MDL), a class (CLS), a command (CMD), and a description (DES). For example, “Printer 1” described in Table A has information including a manufacturer “ABC”, a model “PRINTER1”, a class “PRINTER”, a command “PDL1” (a private print control command of the ABC company), a description “ABC”, and a device ID “PRINTER1”. The device ID is associated with a device management system DevMg1 and a device management application App1.

Referring to the flowchart illustrated in FIG. 4, when Printer 1 is connected to the client computer 100, a printer queue having a name according to the manufacturer and the model is generated, and the device management system DevMg1 and the device management application App1 are automatically installed. The device management system DevMg1 and the device management application App1 manage Printer 1. When Printer 2 is connected to the client computer 100, the device management application 1057 associated with Printer 2 is App1, similar to the case of Printer 1. When App1 has already been installed, App1 is not newly installed.

When the device management system manages printer queues corresponding to different functions of one peripheral apparatus. When both printer queues are deleted, the OS 1053 deletes the device management system. For example, one peripheral apparatus having printer and FAX functions is connected to the client computer 100, one device management system manages a printer queue for the printer and a printer queue for the FAX.

However, the device management system cannot manage printer queues corresponding to respective functions of a plurality of peripheral apparatuses to which different (Internet Protocol) IP addresses are assigned. For example, one device management system is not capable of managing both a printer queue corresponding to a first peripheral apparatus to which a first IP address is assigned, and a printer queue corresponding to a second peripheral apparatus to which a second IP address (different from the first IP address) is assigned. In the present specifications, the queue corresponding to the FAX driver is also referred to as a printer queue.

On the other hand, the device management application is also capable of managing printer queues corresponding to respective functions of a plurality of peripheral apparatuses to which different IP addresses are assigned. For example, one device management application is capable of managing both the printer queue corresponding to the first peripheral apparatus to which the first IP address is assigned, and the printer queue corresponding to the second peripheral apparatus to which the second IP address (different from the first IP address) is assigned. Specifically, the device management application is also capable of managing printer queues corresponding to respective functions of peripheral apparatuses in different housings.

When the OS 1053 stores Media Access Control (MAC) addresses of peripheral apparatuses, the device management system cannot manage printer queues corresponding to respective functions of a plurality of peripheral apparatuses to which different MAC addresses are assigned. On the other hand, the device management application is also capable of managing printer queues corresponding to respective functions of a plurality of peripheral apparatuses to which different MAC addresses are assigned. These IP addresses and MAC addresses are collectively referred to as an address.

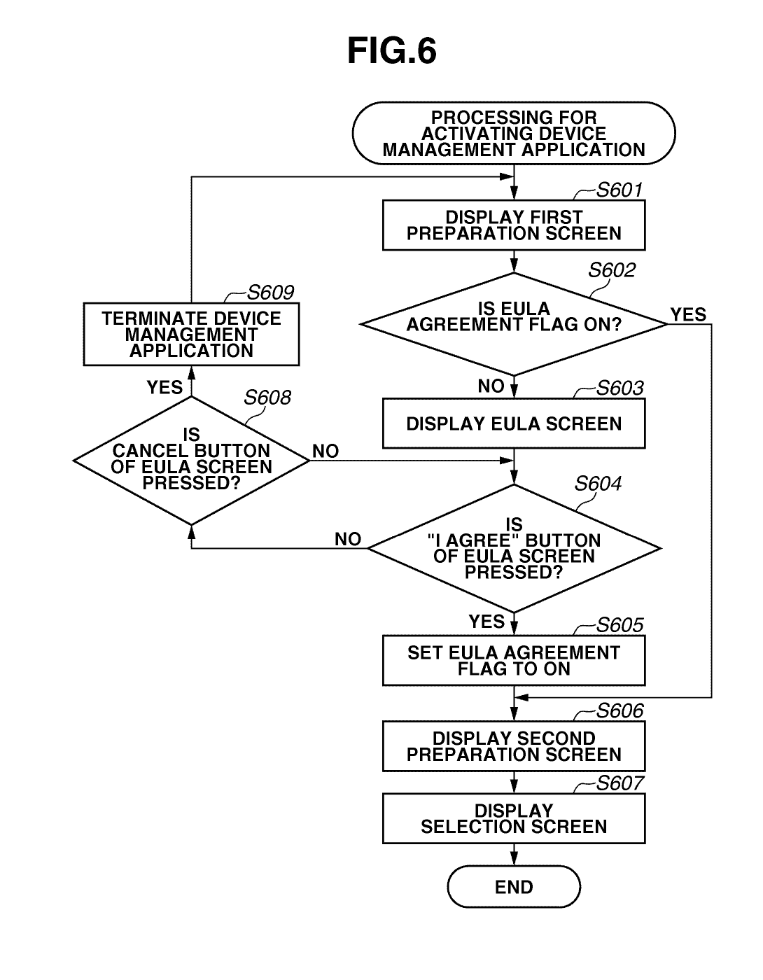

The following describes processing for activating the device management application 1057 according to the present exemplary embodiment, with reference to the flowchart illustrated in FIG. 6. Programs of the device management application 1057 related to the subsequent flowcharts are stored in the auxiliary storage unit 105 of the computer 100, loaded into the RAM 1022, and executed by the CPU 101.

Before this flowchart is started, the OS 1053 instructs the device management application 1057 to start. Specifically, when the OS 1053 recognizes that the tile 301 of the device management application 1057 has been pressed, the OS 1053 instructs the device management application 1057 to start.

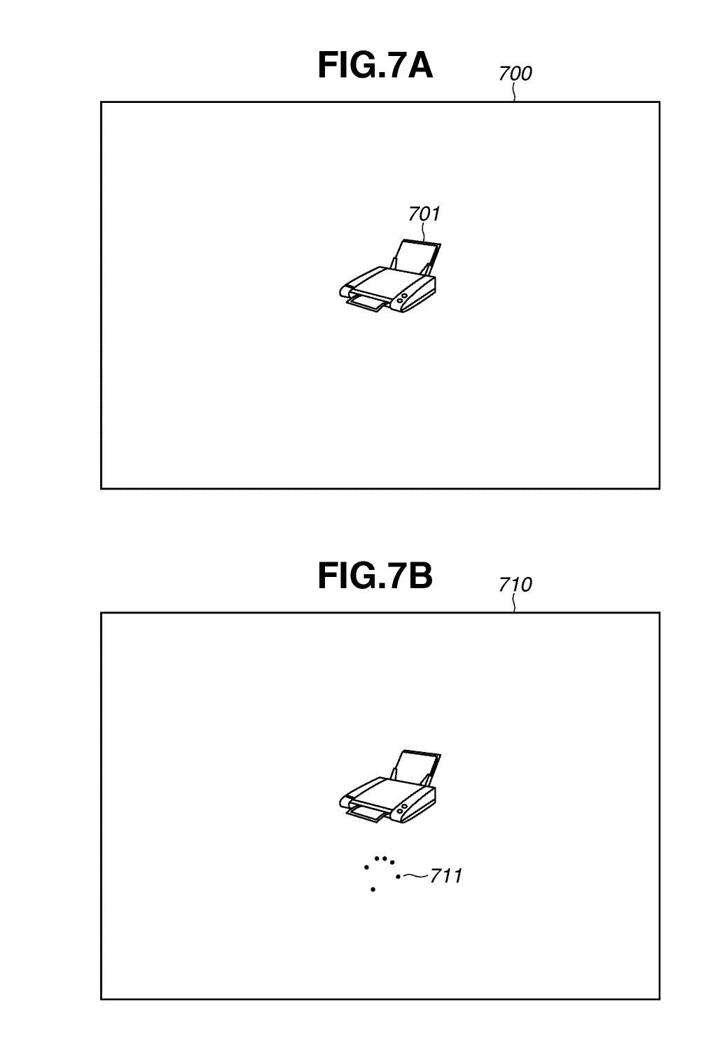

In step S601, the device management application 1057 displays a first preparation screen 700. FIG. 7A illustrates an example of the first preparation screen 700 of the device management application 1057 according to the present exemplary embodiment.

In step S602, the device management application 1057 determines whether the EULA agreement flag is ON. The EULA agreement flag is information stored in the device management application 1057. The EULA agreement flag is set to OFF immediately after the device management application 1057 is installed. Therefore, when the device management application 1057 is activated for the first time in the information processing apparatus, the device management application 1057 performs the processing in step S603 (described below).

When the EULA agreement flag is determined to be ON (YES in step S602), the processing proceeds to step S606. Otherwise, when the EULA agreement flag is determined to be OFF (NO in step S602), the processing proceeds to step S603.

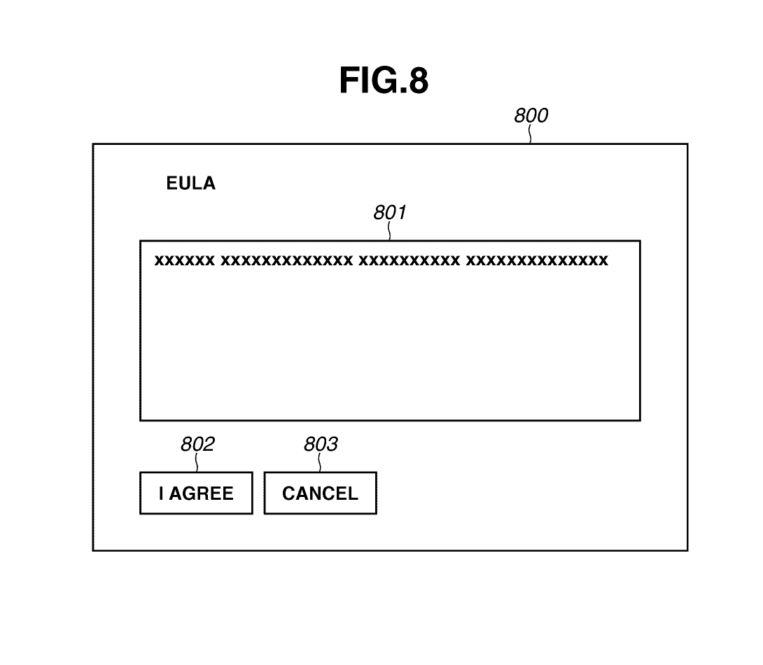

In step S603, the device management application 1057 displays an EULA screen 800. FIG. 8 illustrates an example of the EULA screen 800 of the device management application 1057 according to the present exemplary embodiment. The EULA screen 800 illustrated in FIG. 8 includes an area 801 displaying the contents of the EULA, an “I AGREE” button 802, and a CANCEL button 803.

In step S604, the device management application 1057 determines whether the “I AGREE” button 802 of the EULA screen 800 has been pressed.

When the “I AGREE” button 802 is determined not to have been pressed (NO in step S604), then in step S608, the device management application 1057 determines whether the CANCEL button 803 of the EULA screen 800 has been pressed. Otherwise, when the CANCEL button 803 is determined not to have been pressed (NO in step S608), the processing returns to step S604. Otherwise, when the CANCEL button 803 is determined to have been pressed (YES in step S608), then in step S609, the device management application 1057 is terminated.

Otherwise, when the “I AGREE” button 802 is determined to have been pressed (YES in step S604), then in step S605, the device management application 1057 updates the EULA agreement flag information stored in the device management application 1057 from OFF to ON, and the processing proceeds to step S606.

In step S606, the device management application 1057 displays a second preparation screen 710. FIG. 7B illustrates an example of the second preparation screen 710 of the device management application 1057 according to the present exemplary embodiment. FIG. 7B illustrates a progress ring 711 in the second preparation screen 710.

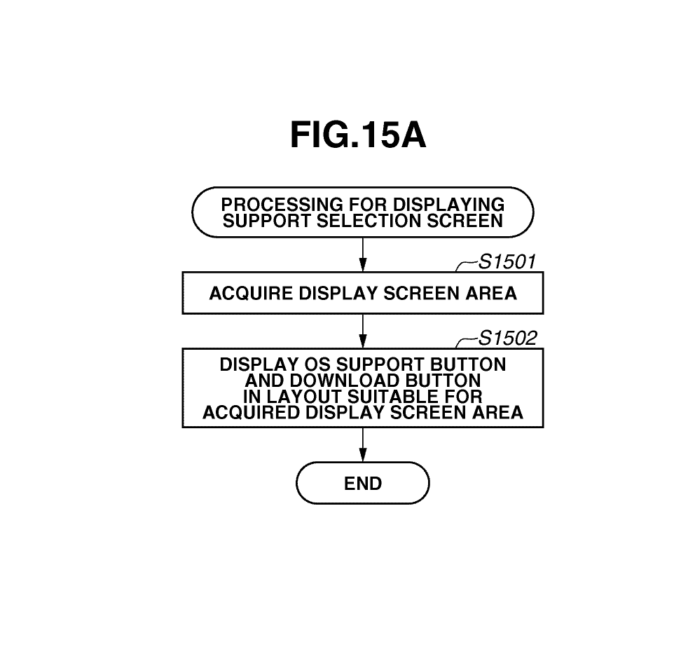

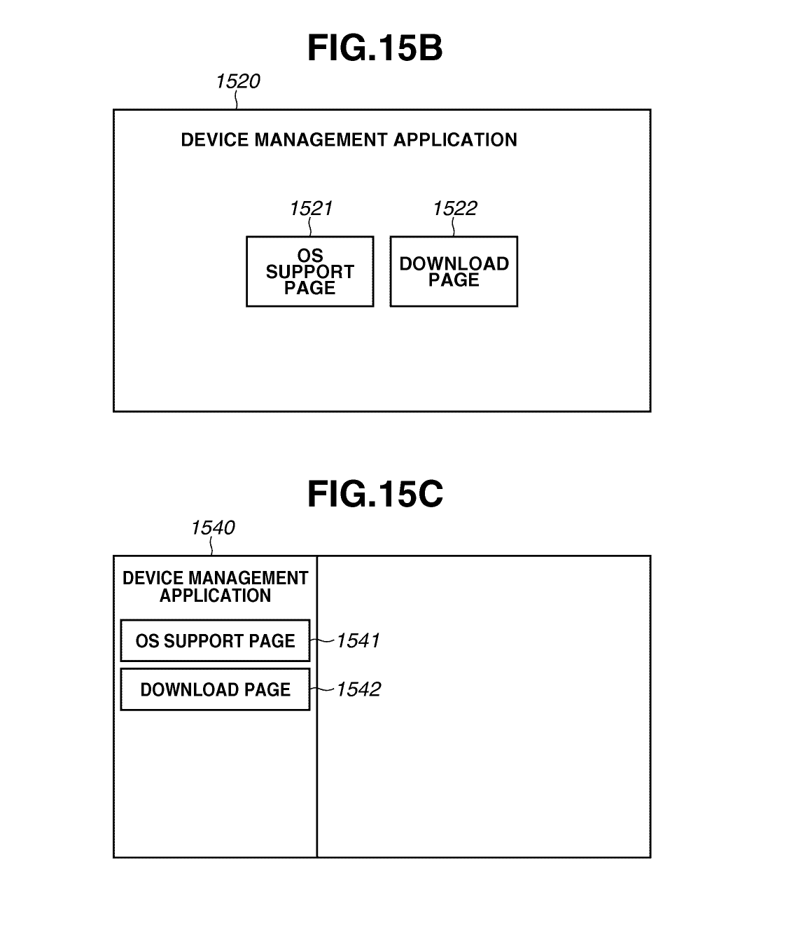

In step S607, the device management application 1057 performs processing for displaying any one of the device selection screens illustrated in FIGS. 11A, 11B, and 11C, or any one of the selection screens illustrated in FIGS. 15B and 15C.

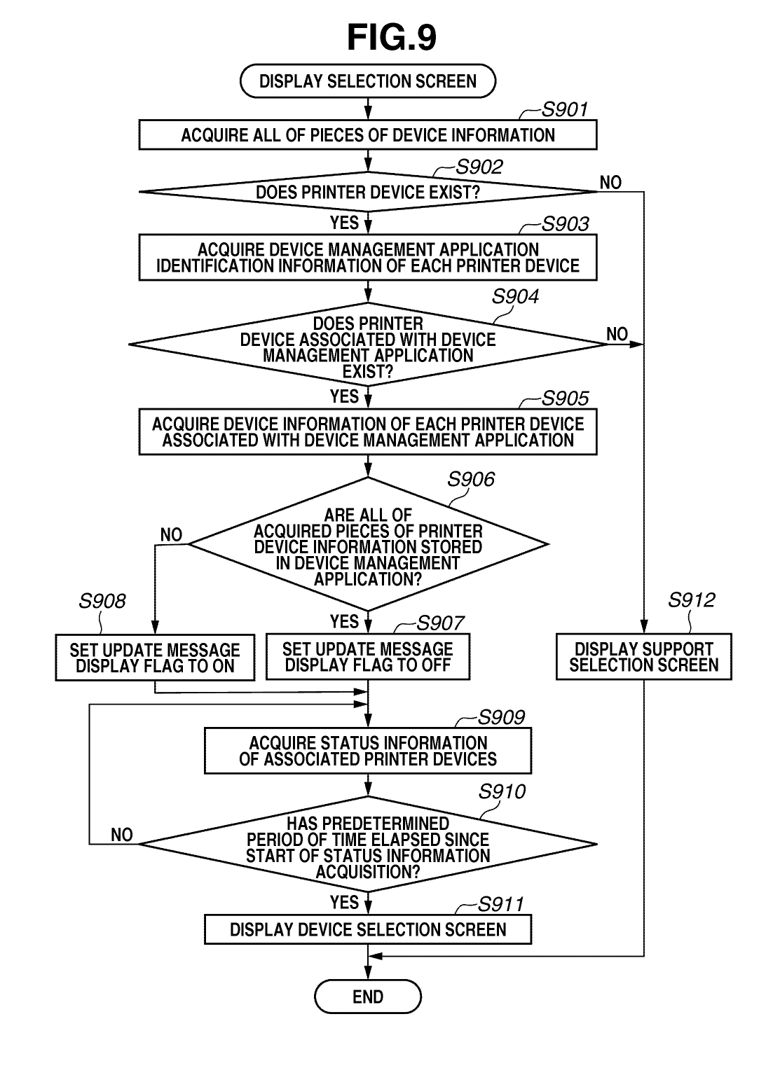

The following describes processing for displaying any one of the device selection screens illustrated in FIGS. 11A, 11B, and 11C, or any one of selection screens illustrated in FIGS. 15B and 15C performed by the device management application 1057 according to the present exemplary embodiment, with reference to the flowchart illustrated in FIG. 9.

In step S901, by using the API of the OS 1053, the device management application 1057 acquires all of pieces of device information (information about the monitor 1041, the printer 1042, etc.) managed by the OS 1053. When device drivers are installed and printer queues are generated, the OS 1053 generates device information including an interface ID, a device class, and a FRIENDLY name on a printer queue basis. The device class is acquired, for example, from the “inf” file of each device driver.

In addition to the device information, the OS 1053 further generates container information on a device basis. The container information includes device management application identification information (for example, name, ID, etc.) and the model name of the corresponding device acquired from the device management control file 1058. The container information is generated on a device basis. Therefore, even in a case where a printer queue for the FAX driver and a printer queue for the printer driver are generated for an MFP, for example, the container information is generated for the MFP. On the other hand, when the monitor 1041 is connected to the client computer 100 and a monitor driver is installed, device information is generated. Specifically, device information for the monitor 1041 is generated on a driver basis. The device information includes the above-described identification information of the container information.

In step S902, the device management application 1057 determines whether any device having the printer class exists in the device information acquired in step S901. The device information acquired in step S901 includes information about the monitor class and the printer class. In the present exemplary embodiment, a device having the printer class is referred to as a printer device.

When no printer is determined to exist in the class information in all of pieces of the acquired device information (NO in step S902), the processing proceeds to step S912.

Otherwise, when a printer is determined to exist in the class information in all of pieces of the acquired device information (YES in step S902), then in step S903, the device management application 1057 acquires the device management application identification information for each printer device. The device management application 1057 acquires the device management application identification information (for example, the name and the ID of the device management application) based on the container information generated by the OS 1053.

In step S904, the device management application 1057 determines whether a printer device associated with the device management application 1057 exists based on the device management application identification information for each printer device acquired in step S903. Specifically, the device management application 1057 determines whether information about the device management application 1057 itself exists in the device management application identification information for each printer device acquired in step S903, to implement step S904. With the processing in step S904, the device management application 1057 can determine whether there exists a printer device (printer queue) which is to be managed by the device management application 1057 itself. When no printer device associated with the device management application 1057 is determined to exist (NO in step S904), the processing proceeds to step S912. Specifically, when the information about the device management application 1057 itself does not exist in the device management application identification information for all printer devices, the processing proceeds to step S912.

In step S912, the device management application 1057 performs processing for displaying any one of the support selection screens illustrated in FIGS. 15B and 15C.

Otherwise, when a printer device associated with the device management application 1057 is determined to exist (YES in step S904), then in step S905, by using the API of the OS 1053, the device management application 1057 acquires information about each printer device associated with the device management application 1057 itself, such as the printer model name and the FRIENDLY name of the printer queue. Specifically, the FRIENDLY name exists in the device information acquired in step S901 and the model name exists in the container information as described above. Therefore, the device management application 1057 acquires these pieces of information from the OS 1053 to implement step S905. Although, in the present exemplary embodiment, the OS 1053 acquires the printer model name and the FRIENDLY name of the printer queue, the information to be acquired is not limited thereto, and may be the device ID of printer devices as long as the printer device can be identified.

In step S906, the device management application 1057 determines whether all of pieces of the device information (model names and FRIENDLY names) acquired in step S905 are stored in the device management application 1057. In the present exemplary embodiment, the device management application 1057 prestores model names and FRIENDLY names of printer devices which are to be managed by the device management application 1057 itself. The device management application 1057 determines whether the model names and the FRIENDLY names acquired in step S905 exist in model names and FRIENDLY names of the printer devices which are to be managed by the device management application 1057 itself. Further, the device management application 1057 may have a file storing a list of printer models which are to be managed by the device management application 1057 itself, and determine whether all of pieces of the relevant device information are stored in the device management application 1057 based on the file of the corresponding printer model list. More specifically, the device management application 1057 is assumed to prestore two different model names (Printer A and Printer B) as printer models which are to be managed by the device management application 1057 itself. In this situation, if the model names acquired in step S905 are only Printer A and Printer B, the result of the determination in step S906 is YES. Otherwise, if the model names acquired in step S905 are Printer A, Printer B, and Printer C, the result of the determination in step S906 is NO.

When all of pieces of the printer model name information acquired in step S905 are determined to be stored in the device management application 1057 (YES in step S906), then in step S907, the device management application 1057 sets the update message display flag to OFF. The update message display flag is information stored in the device management application 1057, and is set to OFF immediately after the device management application 1057 is installed.

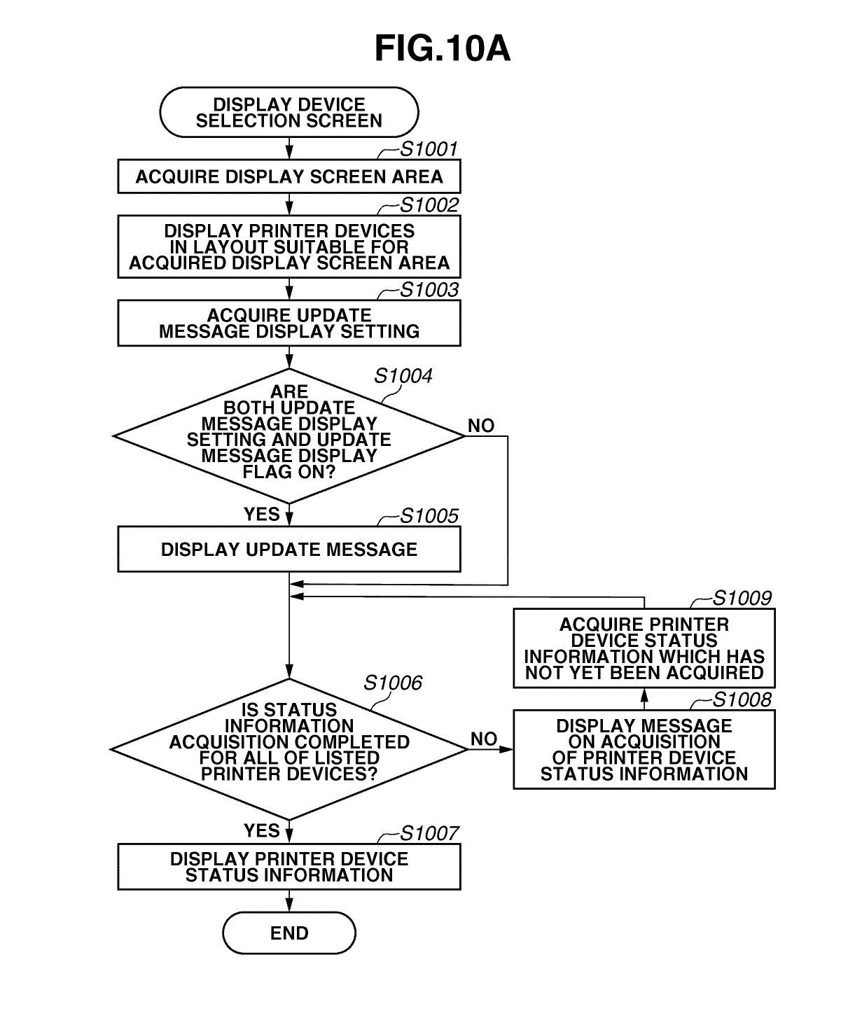

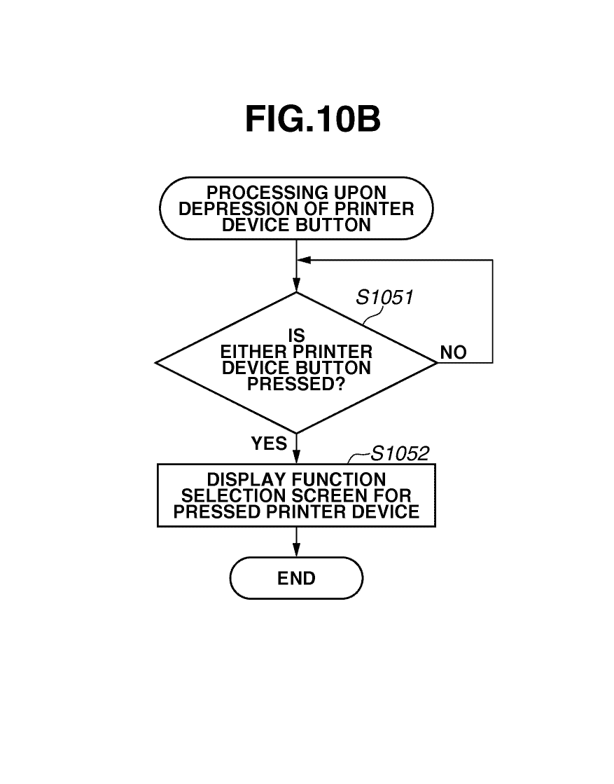

Otherwise, when not all of pieces of the printer model name information acquired in step S905 are determined to be stored in the device management application 1057 (NO in step S906), then in step S908, the device management application 1057 sets the update message display flag to ON. This flag will be used by the processing of the flowchart illustrated in FIG. 10A (described below).

In step S909, the device management application 1057 acquires the status information of printer devices associated with the device management application 1057. The status information according to the present exemplary embodiment refers to the printer online and offline information, and error information, such as a toner out error and a paper out error. Of course, the status information may be any information regarding printer statuses.

In step S910, the device management application 1057 determines whether a predetermined period of time has elapsed since the status information acquisition processing was started in step S909.

When the predetermined period of time is determined not to have elapsed since the status information acquisition processing was started (NO in step S910), the processing returns to step S909.

Otherwise, when the predetermined period of time is determined to have elapsed since the status information acquisition processing was started (YES in step S910), the device management application 1057 once interrupts the status information acquisition processing, and the processing proceeds to step S911. In step S911, the device management application 1057 performs processing for displaying any one of the device selection screens illustrated in FIGS. 11A, 11B, and 11C.

The following describes processing for displaying any one of the device selection screens illustrated in FIGS. 11A, 11B, and 11C performed by the device management application 1057 according to the present exemplary embodiment, with reference to the flowchart illustrated in FIG. 10A.

In step S1001, by using the API of the OS 1053, the device management application 1057 acquires screen area information for displaying the device management application 1057. In step S1002, the device management application 1057 displays the printer devices acquired in step S905 in a layout suitable for the screen area information acquired in step S1001. Examples of device selection screens according to the present exemplary embodiment are illustrated in FIGS. 11A, 11B, and 11C. FIG. 11A illustrates an example of the device selection screen 1100 suitable for a horizontally long screen area for displaying the device management application 1057. The device selection screen 1100 includes the printer devices associated with the device management application 1057 as printer device buttons 1101 and 1102. The device selection screen 1100 further includes images 1103 of the printer devices stored in the device management application 1057, FRIENDLY names 1104 of the printer devices acquired in step S905, and the status information 1105 of the printer devices acquired in step S909.

FIG. 11B illustrates an example of the device selection screen 1120 suitable for a vertically long screen area for displaying the device management application 1057. Elements 1121 to 1125 of the device selection screen 1120 are similar to the elements 1101 to 1105 of the device selection screen 1100, respectively, and redundant descriptions thereof will be omitted.

FIG. 11C illustrates an example of the device selection screen 1140 suitable for a small screen area for displaying the device management application 1057. Elements 1141 to 1145 of the device selection screen 1140 are similar to the elements 1101 to 1105 of the device selection screen 1100, respectively, and redundant descriptions thereof will be omitted. An another area portion 1146 displays another application.

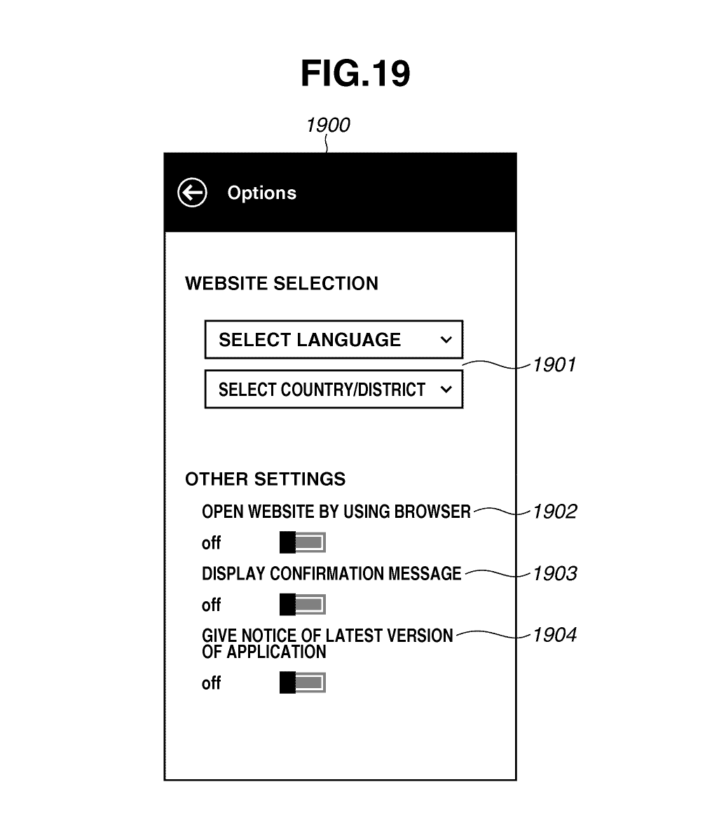

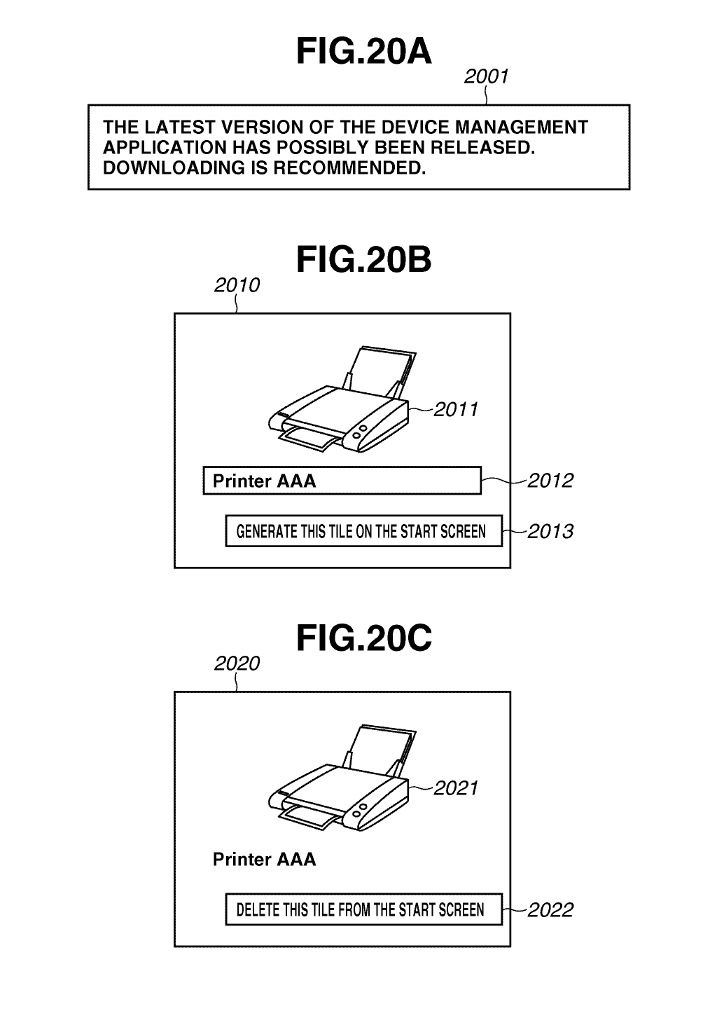

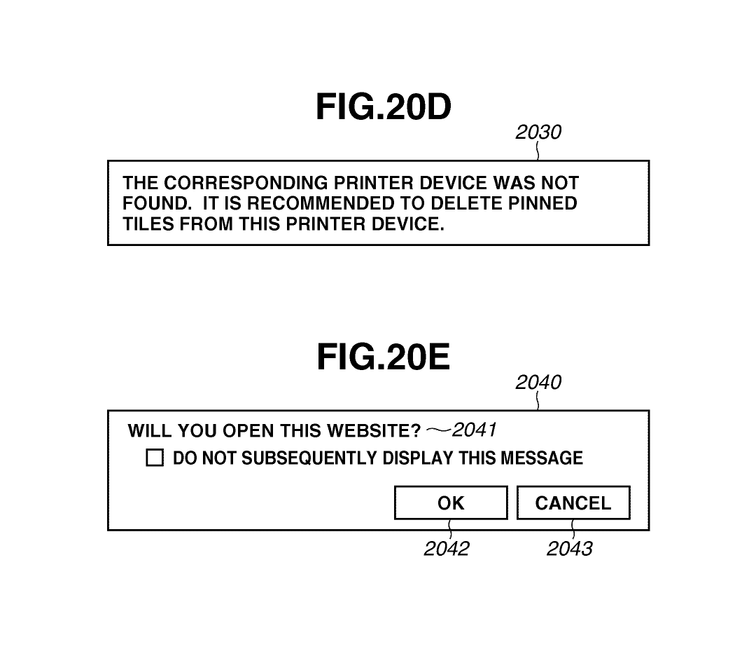

In step S1003, the device management application 1057 acquires the update message display setting. FIG. 19 illustrates an example of a setting screen which enables setting update messages according to the present exemplary embodiment. A setting screen 1900 illustrated in FIG. 19 is invoked from the device management application 1057. The user makes settings about the device management application 1057 on this screen. Website selection buttons 1901 enable setting a country for support website display. A website display setting button 1902 enables setting whether a website is to be displayed within the device management application 1057 or by using another application. A confirmation dialog display setting button 1903 enables setting whether a confirmation dialog is to be displayed. When the confirmation dialog display setting button 1903 is set to ON, pressing a button 1803 for instructing to open a website displays the message illustrated in FIG. 20E.

An update message display setting button 1904 enables setting whether a message for prompting the user to download the latest version of the device management application 1057 is to be displayed. Specifically, in step S1003, the device management application 1057 acquires the setting of the update message display setting button 1904.

In step S1004, the device management application 1057 determines whether both the update message display setting acquired in step S1003 and the update message display flag stored in the device management application 1057 are ON.

When both the update message display setting and the update message display flag are determined to be ON (YES in step S1004), then in step S1005, the device management application 1057 displays an update message 2001. Then, the processing proceeds to step S1006. FIG. 20A illustrates an example of the update message 2001 according to the present exemplary embodiment. Processing for notifying the update message will be described below. The device management application 1057 is assumed to prestore two different model names (Printer A and Printer B) as printer models which are to be managed by the device management application 1057 itself. When Printer A, Printer B, and Printer C are found as printer devices associated with the device management application 1057 through the processing in step S904 in this situation, a new version of the device management application 1057 which needs to manages Printer A, Printer B, and Printer C is highly likely to exist. Therefore, the device management application 1057 performs the processing in step S1005.

Otherwise, when at least one of the update message display setting and the update message display flag is determined not to be ON (NO in step S1004), the processing proceeds to step S1006.

In step S1006, the device management application 1057 determines whether status information acquisition is completed for all of the printer devices listed in the device selection screen 1100. When status information acquisition is determined not to be completed for all of the printer devices (NO in step S1006), then in step S1008, the device management application 1057 displays as the status information 1105 on the device selection screen a message on the acquisition of printer device status information. In step S1009, the device management application 1057 acquires printer device status information which has not yet been acquired.

Otherwise, when status information acquisition is determined to be completed for all of the printer devices (YES in step S1006), then in step S1007, the device management application 1057 updates the status information 1105 of the printer devices on the device selection screen.

The following describes processing performed when the user presses either of the printer device buttons 1101 and 1102 of the device selection screen 1100 according to the present exemplary embodiment, with reference to the flowchart illustrated in FIG. 10B.

In step S1051, the device management application 1057 determines whether either of the printer device buttons 1101 and 1102 in the device selection screen 1100 has been pressed.

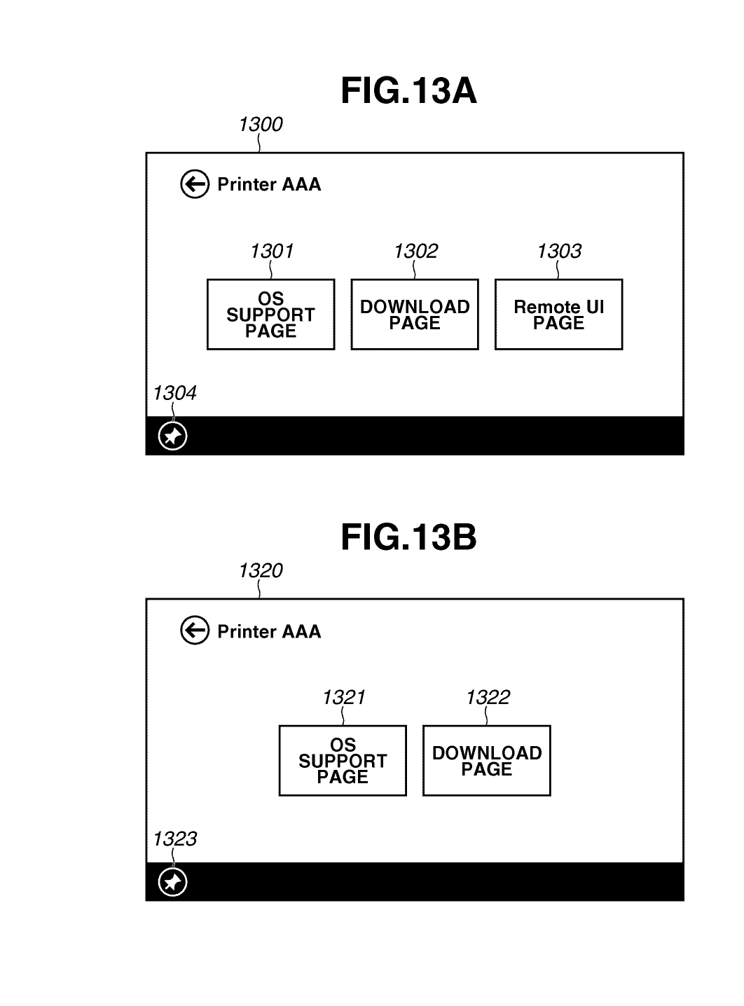

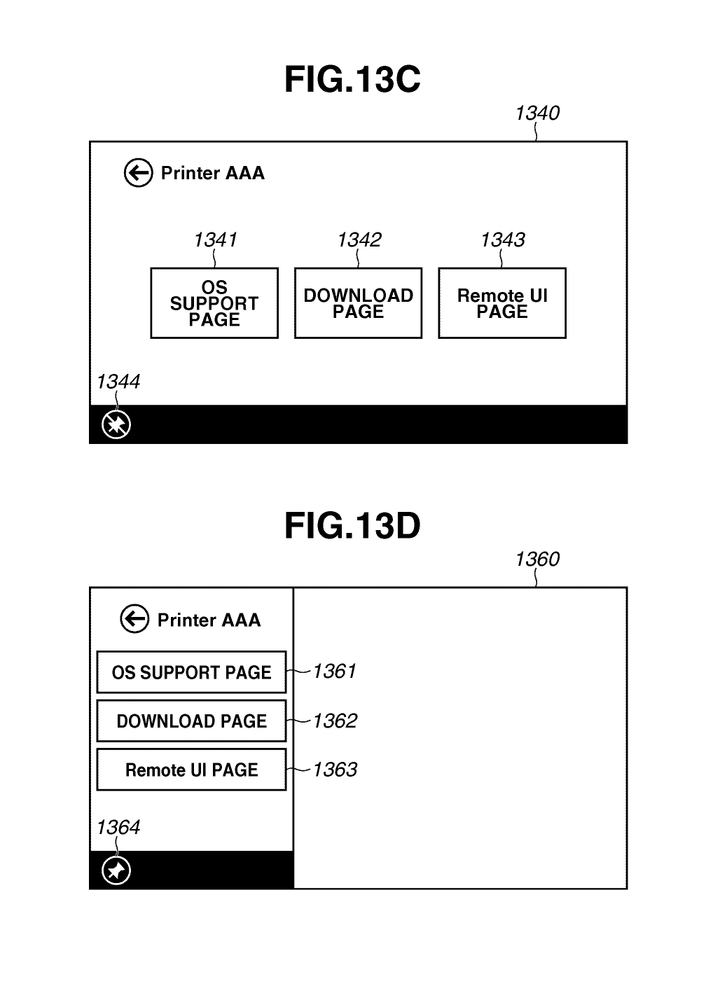

When either of the printer device buttons 1101 and 1102 is determined to have been pressed (YES in step S1051), then in step S1052, the device management application 1057 displays any one of the function selection screens (FIGS. 13A, 13B, 13C, and 13D) for the pressed printer device.

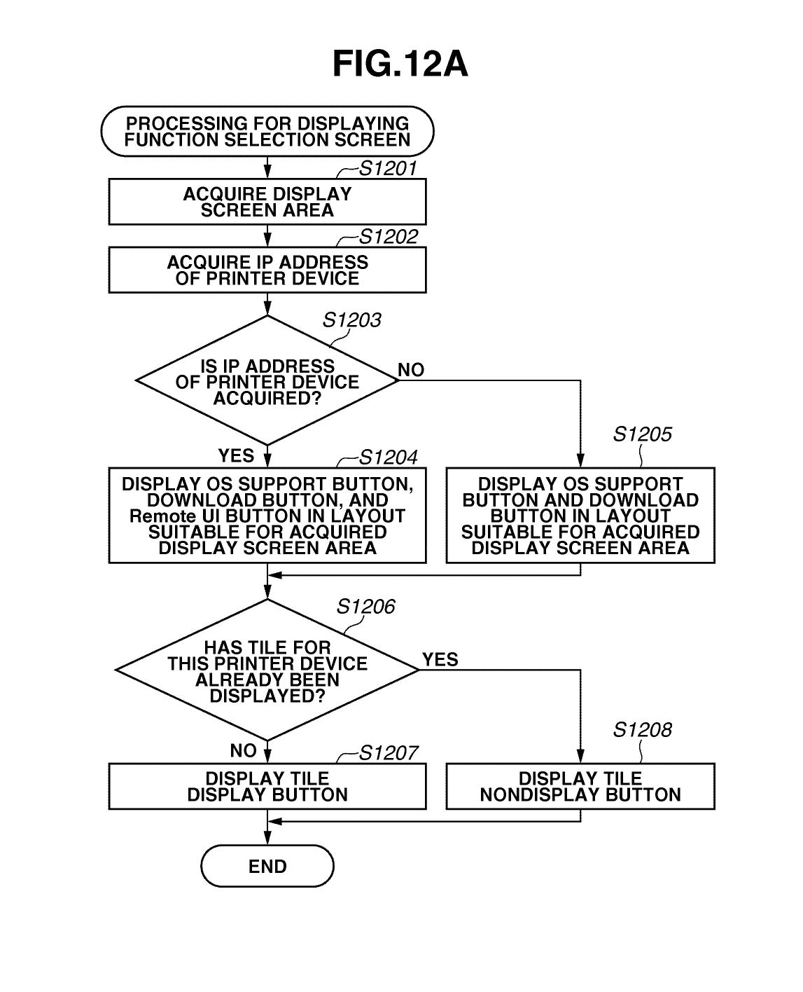

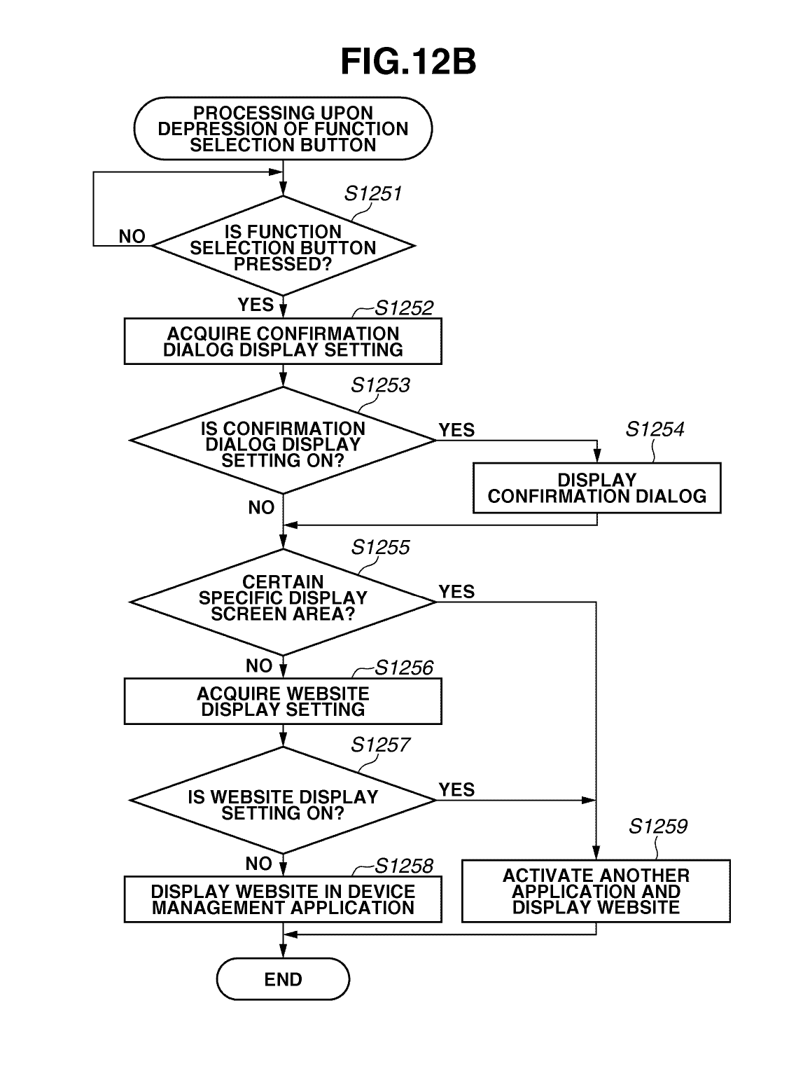

The following describes processing for displaying the function selection screens illustrated in FIGS. 13A, 13B, 13C, and 13D performed by the device management application 1057 according to the present exemplary embodiment, with reference to the flowchart illustrated in FIG. 12A.

In step S1201, by using the API of the OS 1053, the device management application 1057 acquires screen area information for displaying the device management application 1057. In step S1202, by using the API of the OS 1053, the device management application 1057 acquires the IP address of the printer device corresponding to the printer device button pressed in step S1051.

In step S1203, the device management application 1057 determines whether the IP address of the printer device has been acquired in step S1202.

When the IP address of the printer device is determined to have been acquired (YES in step S1203), then in step S1204, the device management application 1057 displays an OS SUPPORT PAGE button 1301, a DOWNLOAD PAGE button 1302, and a Remote user interface (UI) PAGE button 1303 in a layout suitable for the display screen area acquired in step S1201. FIG. 13A illustrates an example of the function selection screen 1300 suitable for a horizontally long display area for displaying the device management application 1057. Although, in the present exemplary embodiment, the OS SUPPORT PAGE button 1301, the DOWNLOAD PAGE button 1302, the Remote UI PAGE button 1303, and the tile display button 1304 are displayed in the function selection screen 1300 illustrated in FIG. 13A, buttons to be displayed are not limited thereto. Any functions button, for example, a button for purchasing ink, a button for displaying detailed device status, and a button for displaying a device driver setting screen may be displayed.

When the user presses the OS SUPPORT PAGE button 1301, a website describing a list of operating systems on which the device driver for the printer device operates is displayed. A list of operating systems specific to the printer device button pressed in step S1051 may be displayed. In a case where pressing the OS SUPPORT PAGE button 1301 displays a website specific to the printer device button pressed in step S1051, the OS SUPPORT PAGE button 1301 is also referred to as a button for displaying information dependent on peripheral apparatuses. Otherwise, when the user presses the OS SUPPORT PAGE button 1301, a website including a list of a plurality of devices including the device for the printer device button pressed in step S1051 may be displayed. When the user selects any one device from the list displayed, a list of operating systems on which the device driver for the selected device is displayed. In a case where pressing the OS SUPPORT PAGE button 1301 displays a website including a list of a plurality of devices, the OS SUPPORT PAGE button 1301 is also referred to as a button for displaying information not dependent on peripheral apparatuses.

When the user presses the DOWNLOAD PAGE button 1302, a website from which the device driver for the printer device can be downloaded is displayed. A download website specific to the printer device button pressed in step S1051 may be displayed. In a case where pressing the DOWNLOAD PAGE button 1302 displays a website specific to the printer device button pressed in step S1051, the DOWNLOAD PAGE button 1302 is also referred to as a button for displaying information dependent on peripheral apparatuses. Otherwise, when the user presses the DOWNLOAD PAGE button 1302, a website including a list of a plurality of devices including the device for the printer device button pressed in step S1051 may be displayed. When the user selects any one device from the list displayed, a download site of the device driver for the selected device is displayed. In a case where pressing the DOWNLOAD PAGE button 1302 displays a website including a list of a plurality of devices, the DOWNLOAD PAGE button 1302 is also referred to as a button for displaying information not dependent on peripheral apparatuses.

When the user presses the Remote UI PAGE button 1303, the remote UI screen for the printer device corresponding to the printer device button pressed in step S1051 is displayed. When displaying this remote UI, the IP address acquired in step S1202 is used. The remote UI is a screen offered by the peripheral apparatus corresponding to the acquired IP address. The remote UI receives an instruction for displaying job history information of the corresponding device, an instruction for displaying detailed status information, and an instruction for controlling the corresponding device. The Remote UI PAGE button 1303 is also referred to as a button for displaying information dependent on peripheral apparatuses. The above-described buttons are not necessarily buttons, and may be, for example, hyperlinks or icons as long as they can display information dependent on peripheral apparatuses. Therefore, a button for displaying information dependent on peripheral apparatuses may be sometimes simply referred to an object.

When the user presses the tile display button 1304, a tile 351 of the printer device corresponding to the printer device button pressed in step S1051 is displayed on the home screen 300 (FIG. 3B), separately from the tile 301.

FIG. 13D illustrates an example of the function selection screen 1360 suitable for a small display area for displaying the device management application 1057. Buttons 1361 to 1364 are similar to the buttons 1301 to 1304 illustrated in FIG. 13A, respectively, and redundant descriptions thereof will be omitted.

Otherwise, when the IP address of the printer device is determined not to have been acquired (NO in step S1203), the processing proceeds to step S1205. The IP address of the printer device is determined not to have been acquired in step S1203, for example, in a case where a printer queue has been generated but the peripheral apparatus corresponding to the printer queue is not connected to the client computer 100. In step S1205, the device management application 1057 displays the function selection screen (FIG. 13B), which includes the OS SUPPORT PAGE button 1321 and the DOWNLOAD PAGE button 1322 in a layout suitable for the display screen area acquired in step S1201. However, the device management application 1057 does not display the Remote UI PAGE button 1303 related to the IP address of the printer device on the function selection screen. FIG. 13B illustrates an example of the function selection screen 1320 suitable for a horizontally long screen area offered by the device management application 1057. The function selection screen 1320 is displayed by the processing in step S1205. Although, in the present exemplary embodiment, the OS SUPPORT PAGE button 1321 and the DOWNLOAD PAGE button 1322 are displayed, any function buttons may be displayed as long as the function of each button is executed.

Buttons 1321 to 1323 are similar to the buttons 1301, 1302, and 1304 illustrated in FIG. 13A, respectively, and redundant descriptions thereof will be omitted.

In step S1206, the device management application 1057 determines whether the tile of this printer device has already been displayed on a home screen 350. When the tile 351 of the printer device is determined to have already been displayed, as illustrated in FIG. 3B (YES in step S1206), then in step S1208, the device management application 1057 displays a tile nondisplay button 1344, as illustrated in FIG. 13C. Otherwise, when the tile 351 of the printer device is determined not to have already been displayed, as illustrated in FIG. 3A (NO in step S1206), then in step S1207, the device management application 1057 displays the tile display button 1304.

The following describes processing upon depression of any one of the function selection buttons (the OS SUPPORT PAGE button 1301, the DOWNLOAD PAGE button 1302, and the Remote UI PAGE button 1303) of the function selection screen 1300 performed by the device management application 1057 according to the present exemplary embodiment, with reference to the flowchart illustrated in FIG. 12B.

In step S1251, the device management application 1057 determines whether any function selection button has been pressed. When any function selection button is determined to have been pressed (YES in step S1251), then in step S1252, the device management application 1057 acquires setting information set with the confirmation dialog display setting button 1903 in the setting screen 1900.

In step S1253, the device management application 1057 determines whether the confirmation dialog display setting is ON. When the confirmation dialog display setting is determined to be ON (YES in step S1253), then in step S1254, the device management application 1057 displays a confirmation dialog 2040 for checking whether a website is to be opened. FIG. 20E illustrates an example of the confirmation dialog 2040 according to the present exemplary embodiment.

In step S1255, the device management application 1057 determines whether the display screen area where the device management application is displayed is a specific display screen area. In the present exemplary embodiment, the device management application 1057 determines whether the display screen area is a small area.

When the display screen area is determined to be a small area, as illustrated in FIG. 11C (YES in step S1255), the processing proceeds to step S1259. Otherwise, when the display screen area is determined not to be a small area (NO in step S1255), the processing proceeds to step S1256.

In step S1256, the device management application 1057 acquires setting information set with the website display setting button 1902 in the setting screen 1900.

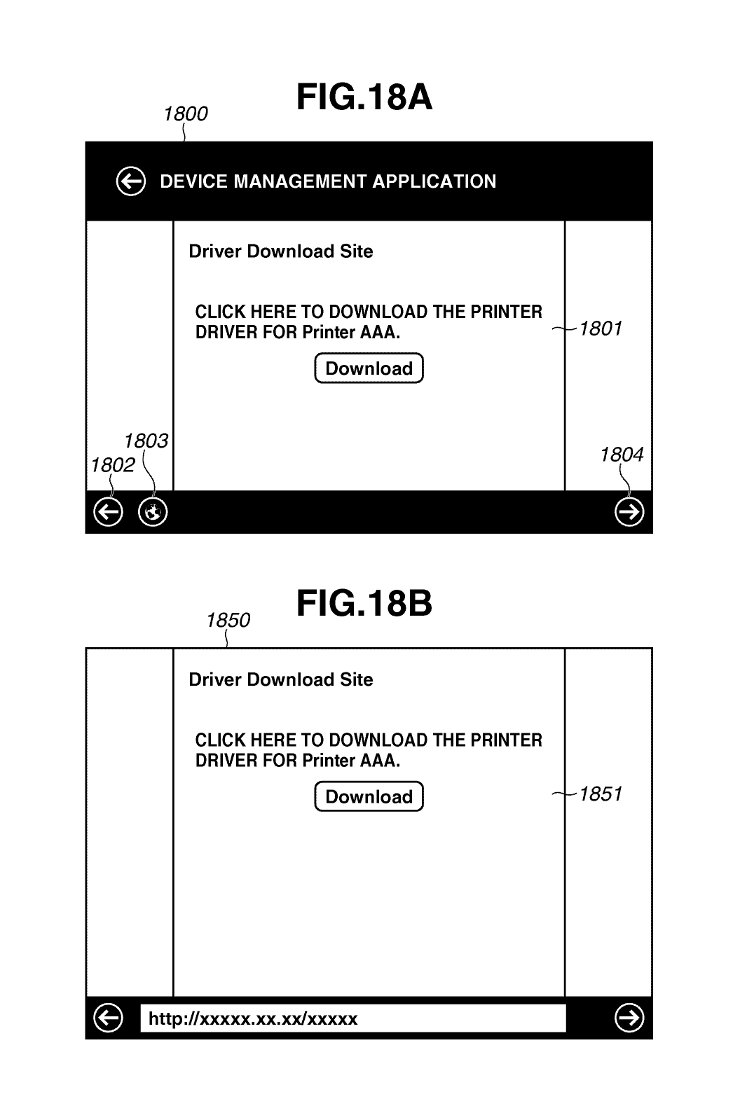

In step S1257, the device management application 1057 determines whether the website display setting is ON. When the website display setting is determined to be ON (YES in step S1257), then in step S1259, the device management application 1057 activates an application 1850 capable of displaying websites, and displays the website by using the application 1850. FIG. 18B illustrates an example of the application 1850 capable of displaying websites according to the present exemplary embodiment Referring to FIG. 18B, a website 1851 is displayed by the application 1850 capable of displaying websites. Specifically, the device management application 1057 requests the OS 1053 to activate the default web application managed by the OS 1053 to implement the processing in step S1259.

Otherwise, when the website display setting is determined to be OFF (NO in step S1257), then in step S1258, the device management application 1057 performs processing for displaying the website displayed in the screen provided by the device management application 1057.

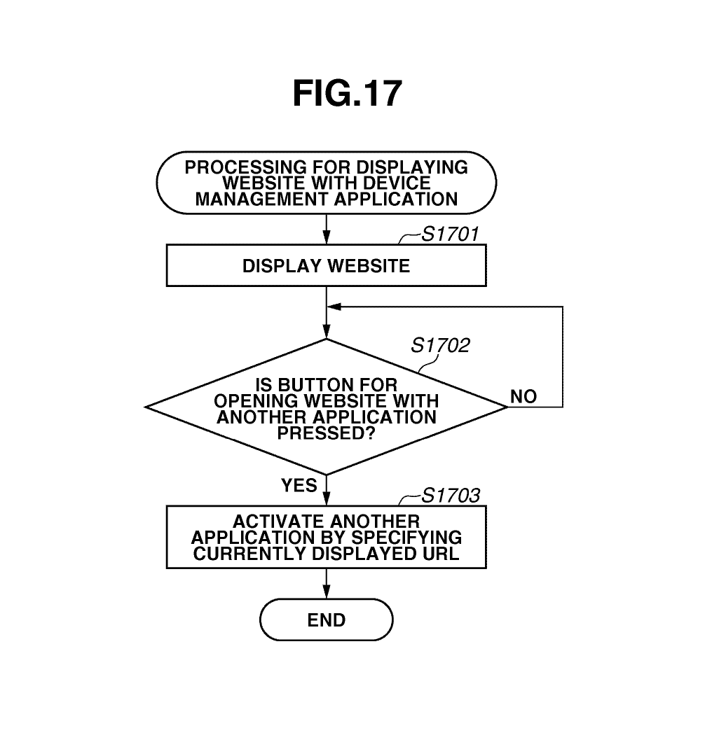

The following describes processing for displaying a website in a screen offered by the device management application 1057 according to the present exemplary embodiment, with reference to the flowchart illustrated in FIG. 17. FIG. 18A illustrates an example of a website in a screen offered by the device management application 1057 according to the present exemplary embodiment. Referring to FIG. 18A, the device management application 1057 displays a website 1801 in a screen 1800 of the device management application 1057. When the user presses a RETURN button 1802, the previous page of the website 1801 is displayed. When the user presses a NEXT button 1804, the next page thereof is displayed. A button 1803 is used to open a website with another application.

In step S1701, the device management application 1057 displays the website 1801 in the screen 1800. In step S1702, the device management application 1057 determines whether the button 1803 for opening a website with another application has been pressed.

When the button 1803 is determined to have been pressed (YES in step S1702), then in step S1703, the device management application 1057 displays, by using the application 1850 capable of displaying websites, the website 1801 currently being displayed in the screen 1800 of the device management application 1057. Specifically, the device management application 1057 requests the OS 1053 to activate the default web application managed by the OS 1053 to implement the processing in step S1703.

The following describes processing in step S912 for displaying the support selection screen performed by the device management application 1057 according to the present exemplary embodiment, with reference to the flowchart illustrated in FIG. 15A.

In step S1501 (FIG. 15A), by using the API of the OS 1053, the device management application 1057 acquires screen area information for displaying the device management application 1057. In step S1502, the OS 1053 displays a support selection screen 1520 in a layout suitable for the display screen area information acquired in step S1501.

FIGS. 15B and 15C illustrate examples of support selection screens according to the present exemplary embodiment. FIG. 15B illustrates an example of a support selection screen 1520 suitable for a horizontally long display area for displaying the device management application 1057. The support selection screen 1520 illustrated in FIG. 15B according to the present exemplary embodiment displays an OS SUPPORT PAGE button 1521 and a DOWNLOAD PAGE button 1522. However, other function buttons may be displayed as long as they are not dependent on printer devices (peripheral apparatuses). When the user presses the OS SUPPORT PAGE button 1521, a website for receiving a selected printer device is displayed. When the user selects a printer device in this website, the website describing a list of operating systems on which the device driver for the selected printer device operates is displayed. When the user presses the DOWNLOAD PAGE button 1522, a download website not dependent on printer devices is displayed. Other buttons may be displayed in the support selection screen 1520 illustrated in FIG. 15B as long as they are not dependent on printer devices. For example, a button for displaying the website of the manufacturer of the device management application 1057 may be displayed. Specifically, the buttons displayed in the support selection screen 1520 illustrated in FIG. 15B are also referred to as buttons for displaying information not dependent on peripheral apparatuses. The above-described buttons are not necessarily buttons, and may be, for example, hyperlinks or icons as long as they can display information dependent on peripheral apparatuses. Therefore, a button for displaying information dependent on peripheral apparatuses may be sometimes simply referred to an object.

FIG. 15C illustrates an example of the support selection screen 1540 suitable for a small display area for displaying the device management application 1057. Buttons 1541 and 1542 are similar to the buttons 1521 and 1522 illustrated in FIG. 15B, and redundant descriptions thereof will be omitted. Thus, in the present exemplary embodiment, the device management application 1057 switches between the screens in FIGS. 13A, 13B, 13C, 13D, 15B, and 15C depending on whether an associated printer device exists. Specifically, when a printer device (printer queue) which is to be managed by the device management application 1057 itself is determined to exist, the device management application 1057 displays any one of the selection screens (FIGS. 13A, 13B, 13C, and 13D) including a first object for displaying information dependent on the selected peripheral apparatus. Otherwise, when no printer device (printer queue) which is to be managed by the device management application 1057 itself is determined to exist, the device management application 1057 displays any one of the selection screens (FIGS. 15B and 15C) including a second object for displaying information not dependent on peripheral apparatuses and not including the first object for displaying information dependent on peripheral apparatuses. This makes it easier for the user to recognize whether there exists a printer device which can be associated with the device management application 1057. Even if there exists no printer device associated with the device management application 1057, the screen 1520 illustrated in FIG. 15B is displayed. Therefore, it is also possible to prompt the user to download the device driver.

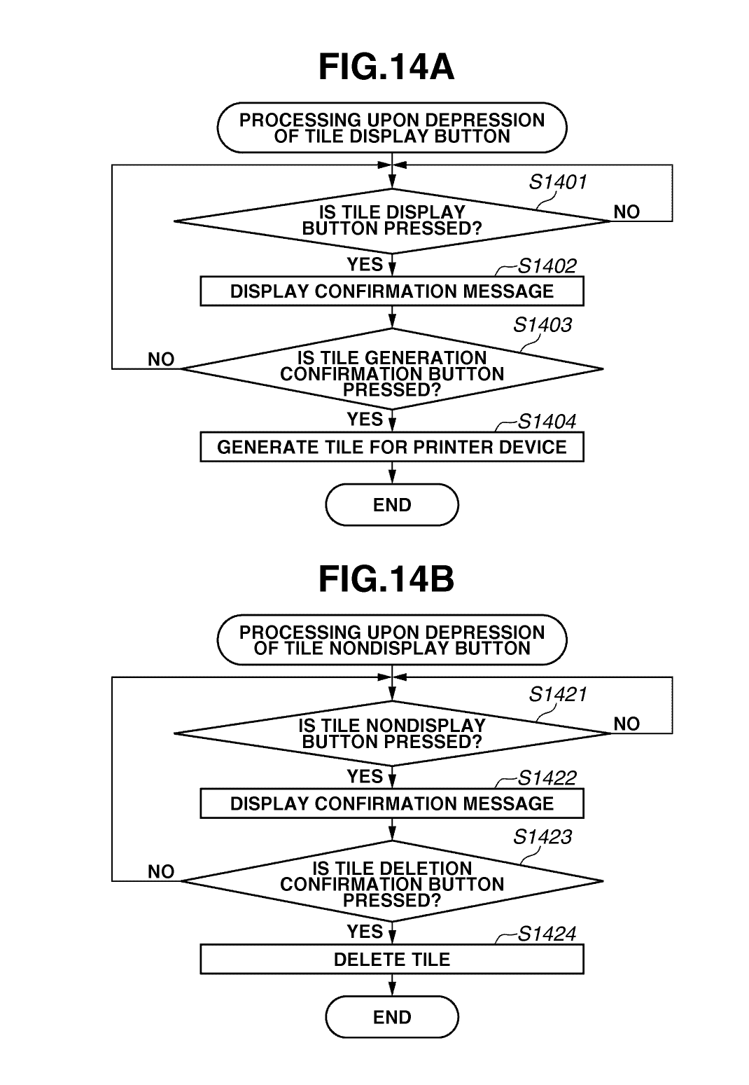

The following describes processing performed when the user presses the tile display button 1304 performed by the device management application 1057 according to the present exemplary embodiment, with reference to the flowchart illustrated in FIG. 14A.

In step S1401 illustrated in FIG. 14A, the device management application 1057 determines whether the tile display button 1304 illustrated in FIG. 13A has been pressed. When the tile display button 1304 is determined to have been pressed (YES in step S1401), then in step S1402, the device management application 1057 displays a tile generation confirmation message 2010. Although, in the present exemplary embodiment, the device management application 1057 displays the tile generation confirmation message 2010, the OS 1053 may display the tile generation confirmation message 2010.

FIG. 20B illustrates an example of the tile generation confirmation message 2010 according to the present exemplary embodiment. The tile generation confirmation message 2010 illustrated in FIG. 20B includes an image 2011 of the tile to be generated, a tile name input column 2012, and a tile generation confirmation button 2013. The image of the currently selected printer device may be used as the image 2011. In step S1403 illustrated in FIG. 14A, the device management application 1057 determines whether the tile generation confirmation button 2013 illustrated in FIG. 20B has been pressed.

When the tile generation confirmation button 2013 is determined not to have been pressed (NO in step S1403), the processing returns to step S1401.

Otherwise, when the tile generation confirmation button 2013 is determined to have been pressed (YES in step S1403), then in step S1404, the device management application 1057 generates the tile 351 for the selected printer device on the home screen 350. For example, when the user presses the tile display button 1304 illustrated in FIG. 13A, a tile of Printer AAA is generated since Printer AAA is selected. When the device management application 1057 generates the tile 351, it assigns a tile ID to the tile 351 to identify which printer device the tile 351 is generated for. Although the device management application 1057 uses as this tile ID the interface ID assigned to each printer queue by the OS 1053, the tile ID may be anything as long as it identifies each printer device. The tile 351 may be sometimes referred to as a display tile for one selected peripheral apparatus.

The following describes processing upon depression of the tile nondisplay button 1344 performed by the device management application 1057 according to the present exemplary embodiment, with reference to the flowchart illustrated in FIG. 14B.

In step S1421 illustrated in FIG. 14B, the device management application 1057 determines whether the tile nondisplay button 1344 illustrated in FIG. 13C has been pressed. When the tile nondisplay button 1344 is determined to have been pressed (YES in step S1421), then in step S1422, the device management application 1057 displays a tile deletion confirmation message 2020. Although, in the present exemplary embodiment, the device management application 1057 displays the tile deletion confirmation message 2020, the OS 1053 may display the tile deletion confirmation message 2020.

FIG. 20C illustrates an example of the tile deletion confirmation message 2020 according to the present exemplary embodiment. The tile deletion confirmation message 2020 illustrated in FIG. 20C will be described below. The tile deletion confirmation message 2020 includes an image 2021 of the tile to be deleted and a tile deletion confirmation button 2022. The image of the currently selected printer device may be used as the image 2021.

In step S1423 illustrated in FIG. 14B, the device management application 1057 determines whether the tile deletion confirmation button 2022 illustrated in FIG. 20C has been pressed.

When the tile deletion confirmation button 2022 is determined not to have been pressed (NO in step S1423), the processing returns to step S1421.

Otherwise, when the tile deletion confirmation button 2022 is determined to have been pressed (YES in step S1423), then in step S1424, the device management application 1057 deletes the tile 351 of the relevant printer device on the home screen 350. For example, the device management application 1057 identifies the interface ID of the currently selected printer device to identify the tile 351 having a tile ID corresponding to the interface ID. The device management application 1057 deletes the identified tile 351.

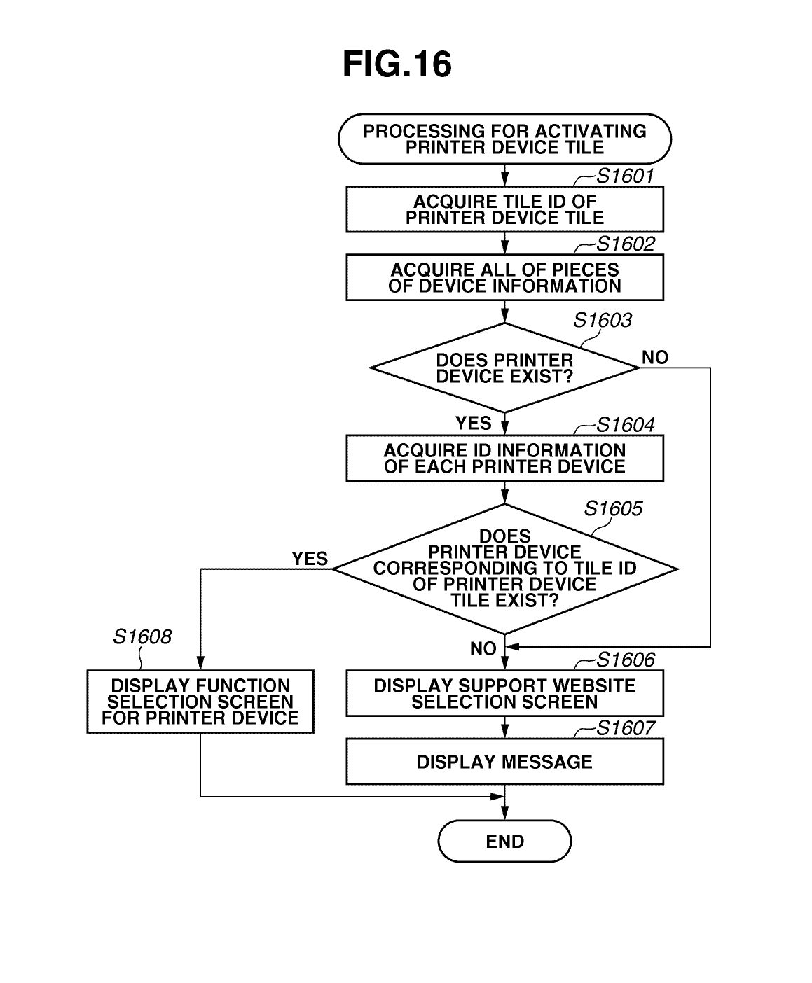

The following describes processing for activating the device management application 1057 according to the present exemplary embodiment performed when the user presses the printer device tile 351 illustrated in FIG. 3B, with reference to the flowchart illustrated in FIG. 16.

When the user presses the printer device tile 351 illustrated in FIG. 3B, the OS 1053 instructs the device management application 1057 to start. Then, the OS 1053 notifies the device management application 1057 of the tile ID set for the pressed printer device tile 351. In step S1601, the device management application 1057 acquires the tile ID of the printer device tile 351.

In step S1602, by using the API of the OS 1053, the device management application 1057 acquires device information for all devices (the monitor 1041, the printer 1042, etc.) connected to the client computer 100. In step S1603, the device management application 1057 determines whether a device having the printer class exists in the device information acquired in step S1602.

When no printer is determined to exist in the class information for all of the acquired devices (NO in the step S1603), the processing proceeds to step S1606.

When a printer is determined to exist in the class information for all of the acquired devices (YES in the step S1603), the processing proceeds to step S1604.

In step S1604, by using the API of the OS 1053, the device management application 1057 acquires ID information for identifying each printer device. Specifically, the device management application 1057 acquires as the ID information the interface ID of each device managed by the OS 1053.

In step S1605, the device management application 1057 determines whether the tile ID acquired in step S1601 exists in the ID information for each printer device acquired in step S1604. When the tile ID acquired in step S1601 is determined to exist in the ID information for each printer device acquired in step S1604 (YES in step S1605), the device management application 1057 determines that there exists a printer device corresponding to the tile ID.

When no printer device corresponding to the printer device tile ID is determined to exist (NO in step S1605), then in step S1606, the device management application 1057 displays the support selection screen 1520. In step S1607, the device management application 1057 displays a message 2030 indicating that the relevant printer device is not found. FIG. 20D illustrates an example of the message 2030 indicating that no printer device according to the present exemplary embodiment was found. A case where the result of the determination in step S1605 is NO will specifically be described below. When a printer queue is deleted, the OS 1053 also deletes the above-described device information. Specifically, when the processing of the flowchart illustrated in FIG. 16 is performed after a printer device tile is generated and then a printer queue is deleted, the result of the determination in step S1605 is NO.

Otherwise, when a printer device corresponding to the printer device tile ID is determined to exist (YES in step S1605), then in step S1608, the device management application 1057 displays the function selection screen 1300 for the relevant printer device. The processing for displaying the function selection screen 1300 for the relevant printer device is similar to the processing of the flowchart illustrated in FIG. 12A.

Upon completion of the processing of the flowchart illustrated in FIG. 9 with the above-described procedures, the device management application 1057 displays the printer-dependent function screen 1100 on the device management application 1057 when there exists a printer queue associated with an application.

Otherwise, when all of printer queues associated with an application have been deleted, the device management application 1057 displays the printer-independent function screen 1520 on the device management application 1057.

This makes it easier for the user to recognize what to do next even if all of printer queues associated with an application have been deleted, thus improving convenience.

The present invention is achieved also by performing the following processing. Specifically, software (program) for achieving the functions of the above-described exemplary embodiments is supplied to a system or an apparatus via a network or various types of storage media, and a computer (or CPU, a micro processing unit (MPU), etc.) of the system or the apparatus reads the program and then executes it.

According to the present exemplary embodiment, the user can be provided with useful information even if there is no associated application.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-214269 filed Sep. 27, 2012, which is hereby incorporated by reference herein in its entirety.

What is claimed is:

1. An information processing apparatus comprising:
a determination unit configured to determine whether there exists a printer queue which is to be managed by a device management application which is installed together with a device driver; and
a display control unit configured to, when the printer queue is determined to exist and a peripheral apparatus is selected, display a first screen for displaying information about the selected peripheral apparatus, and to, when the printer queue is determined not to exist, display a second screen different from the first screen.

2. The information processing apparatus according to claim 1, wherein, when the printer queue is determined to exist, the display control unit displays a device selection screen for receiving selection of a peripheral apparatus corresponding to the printer queue associated with the device management application and, after a peripheral apparatus is selected in the device selection screen, the display control unit displays the first screen.

3. The information processing apparatus according to claim 1, further comprising a generation unit configured to, when an instruction for displaying a display tile for the one peripheral apparatus is received in a selection screen for the one peripheral apparatus, generate the display tile for the one peripheral apparatus,
wherein the generated display tile is displayed on a home screen offered by an OS.

4. The information processing apparatus according to claim 3, wherein, when the selection screen for the one peripheral apparatus is displayed in a state where the display tile is displayed on the home screen, the display control unit displays the selection screen which does not receive the instruction for displaying the display tile.

5. The information processing apparatus according to claim 1, wherein, when the printer queue is determined to exist and an IP address of the one selected peripheral apparatus cannot be acquired, the display control unit displays the first screen not including a first object for displaying information dependent on the selected peripheral apparatus but including a second object for displaying information not dependent on the selected peripheral apparatus.

6. The information processing apparatus according to claim 5, wherein, when the first object is selected, the display control unit displays a screen for controlling the peripheral apparatus, and, when the second object is selected, the display control unit displays a screen for selecting a peripheral apparatus to download a device driver.

7. A control method comprising:
determining whether there exist a printer queue which is to be managed by a device management application which is installed together with a device driver; and
displaying, when the printer queue is determined to exist and a peripheral apparatus is selected, a first screen for displaying information about the selected peripheral apparatus, and displaying, when the printer queue is determined not to exist, a second screen different from the first screen.

8. The control method according to claim 7, further comprising displaying, when the printer queue is determined to exist, a device selection screen for receiving selection of a peripheral apparatus corresponding to the printer queue associated with the device management application, and displaying the first screen after a peripheral apparatus is selected in the device selection screen.

9. The control method according to claim 7, further comprising generating, when an instruction for displaying a display tile for the one peripheral apparatus is received in a selection screen for the one peripheral apparatus, the display tile for the one peripheral apparatus,
wherein the generated display tile is displayed on a home screen offered by an OS.

10. The control method according to claim 9, further comprising displaying, when the selection screen for the one peripheral apparatus is displayed in a state where the display tile is displayed on the home screen, the selection screen which does not receive the instruction for displaying the display tile.

11. The control method according to claim 7, further comprising displaying, when the printer queue is determined to exist and an IP address of the one selected peripheral apparatus cannot be acquired, the first screen not including a first object for displaying information dependent on the selected peripheral apparatus but including a second object for displaying information not dependent on the selected peripheral apparatus.

12. The control method according to claim 11, further comprising displaying, when the first object is selected, a screen for controlling the peripheral apparatus, and, displaying, when the second object is selected, a screen for selecting a peripheral apparatus to download a device driver.

13. A storage medium storing a program that causes a computer to execute a method comprising:
determining whether there exist a printer queue which is to be managed by a device management application which is installed together with a device driver; and
displaying, when the printer queue is determined to exist and a peripheral apparatus is selected, a first screen for displaying information about the selected peripheral apparatus, and displaying, when the printer queue is determined not to exist, a second screen different from the first screen.

14. The storage medium according to claim 13, wherein the method further comprises displaying, when the printer queue is determined to exist, a device selection screen for receiving selection of a peripheral apparatus corresponding to the printer queue associated with the device management application, and displaying the first screen after a peripheral apparatus is selected in the device selection screen.

15. The storage medium according to claim 13, wherein the method further comprises generating, when an instruction for displaying a display tile for the one peripheral apparatus is received in a selection screen for the one peripheral apparatus, the display tile for the one peripheral apparatus,
wherein the generated display tile is displayed on a home screen offered by an OS.

16. The storage medium according to claim 15, wherein the method further comprises displaying, when the selection screen for the one peripheral apparatus is displayed in a state where the display tile is displayed on the home screen, the selection screen which does not receive the instruction for displaying the display tile.

17. The storage medium according to claim 13, wherein the method further comprises displaying, when the printer queue is determined to exist and an IP address of the one selected peripheral apparatus cannot be acquired, the first screen not including a first object for displaying information dependent on the selected peripheral apparatus but including a second object for displaying information not dependent on the selected peripheral apparatus.

18. The storage medium according to claim 17, wherein the method further comprises displaying, when the first object is selected, a screen for controlling the peripheral apparatus, and, displaying, when the second object is selected, a screen for selecting a peripheral apparatus to download a device driver.
